(19) United States
(12) Patent Application Publication
(10) Pub. No.: US 2023/0070510 A1
(43) Pub. Date: Mar. 9, 2023

(54) TRANSMISSION ORDER DETERMINATION FOR APERIODIC CHANNEL STATE INFORMATION

(71) Applicant: QUALCOMM Incorporated, San Diego, CA (US)

(72) Inventors: Muhammad Sayed Khairy ABDELGHAFFAR, San Jose, CA (US); Wei YANG, San Diego, CA (US); Seyedkianoush HOSSEINI, San Diego, CA (US); Wanshi CHEN, San Diego, CA (US); Yi HUANG, San Diego, CA (US); Krishna Kiran MUKKAVILLI, San Diego, CA (US)

(21) Appl. No.: 17/759,827

(22) PCT Filed: Feb. 20, 2020
(86) PCT No.: PCT/CN2020/076034

§ 371 Date: Jul. 29, 2022

(51) Int. Cl. H04L 5/00; H04B 7/06; H04W 72/14

(52) U.S. Cl. CPC H04L 5/0057; H04B 7/0626; H04L 5/0091; H04W 72/14; H04L 5/0055

(57) ABSTRACT

Methods, systems, and devices for wireless communications are described. A receiving device (such as a user equipment (UE)) may receive a downlink grant including an indication to report a first channel state information and a second grant including an indication to report a second channel state information. In some cases, the second grant may be received after the downlink grant. The UE may determine a transmission order associated with the first channel state information and the second channel state information based on a configuration, and may transmit the first channel state information and the second channel state information according to the transmission order.

### CROSS REFERENCE

The present Application is a 371 national stage filing of International PCT Application No. PCT/CN2020/076034 by ABDELGHAFFAR et al. entitled “TRANSMISSION ORDER DETERMINATION FOR APERIODIC CHANNEL STATE INFORMATION,” filed Feb. 20, 2020; which is assigned to the assignee hereof, and which is expressly incorporated by reference in its entirety herein.

### TECHNICAL FIELD

The following relates generally to wireless communications and more specifically to transmission order determination for aperiodic channel state information.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). Current techniques for channel state information report transmission may be deficient.

### SUMMARY

The described techniques relate to improved methods, systems, devices, and apparatuses that support transmission order determination for aperiodic channel state information. Generally, the described techniques provide for receiving or otherwise identifying a configuration for transmitting multiple aperiodic channel state information reports associated with multiple downlink grants or downlink and uplink grants. In some scenarios, a receiving device (such as a user equipment (UE)) may be capable of receiving multiple grants. For example, the UE may receive a downlink grant triggering a first aperiodic channel state information and a second downlink grant or uplink grant triggering a second aperiodic channel state information, The UE may be configured with one or more rules to efficiently define an ordering for multiple aperiodic channel state information triggered by multiple grants (such as downlink grants or downlink and uplink grants). In some examples, the aperiodic channel state information reports may be associated with a low latency communication. In some examples, a UE may receive a downlink grant triggering a channel state information report and a second grant (downlink or uplink) triggering a second aperiodic channel state information report. In some cases, the UE may receive the first grant prior to receiving the second grant. The UE may determine a transmission order based on a configuration received from a base station, and may then transmit the first aperiodic channel state information report and the second aperiodic channel state information report according to the transmission order.

A method of wireless communication at a UE is described. The method may include receiving a downlink grant including an indication to report a first channel state information, receiving a second grant including an indication to report a second channel state information, where the second grant is received after the downlink grant, determining a transmission order associated with the first channel state information and the second channel state information based on a configuration, and transmitting the first channel state information and the second channel state information according to the transmission order.

An apparatus for wireless communication at a UE is described. The apparatus may include a processor, memory coupled with the processor, and instructions stored in the memory. The instructions may be executable by the processor to cause the apparatus to receive a downlink grant including an indication to report a first channel state information, receive a second grant including an indication to report a second channel state information, where the second grant is received after the downlink grant, determine a transmission order associated with the first channel state information and the second channel state information based on a configuration, and transmit the first channel state information and the second channel state information according to the transmission order.

Another apparatus for wireless communication at a UE is described. The apparatus may include means for receiving a downlink grant including an indication to report a first channel state information, receiving a second grant including an indication to report a second channel state information, where the second grant is received after the downlink grant, determining a transmission order associated with the first channel state information and the second channel state information based on a configuration, and transmitting the first channel state information and the second channel state information according to the transmission order.

A non-transitory computer-readable medium storing code for wireless communication at a UE is described. The code may include instructions executable by a processor to receive a downlink grant including an indication to report a first channel state information, receive a second grant including an indication to report a second channel state information, where the second grant is received after the downlink grant, determine a transmission order associated with the first channel state information and the second channel state information based on a configuration, and transmit the first channel state information and the second channel state information according to the transmission order.

Some examples of the method, apparatuses, and non-transitory computer-readable medium described herein may further include operations, features, means, or instructions for transmitting, to a base station, UE capability information indicating a capability of the UE to support the transmission order, and receiving the configuration from the base station, where the configuration may be based on the UE capability information.

Some examples of the method, apparatuses, and non-transitory computer-readable medium described herein may further include operations, features, means, or instructions for determining that the second grant may be a second downlink grant, identifying that the first channel state information and the second channel state information may be associated with a first aperiodic channel state information type, and determining, based on the identifying, a first acknowledgement associated with the downlink grant and a second acknowledgement associated with the second downlink grant.

In some examples of the method, apparatuses, and non-transitory computer-readable medium described herein, the configuration indicates that the first channel state information and the first acknowledgement may be to be transmitted in a first slot and the second channel state information and the second acknowledgement may be to be transmitted in a second slot, the first slot being no later than the second slot.

Some examples of the method, apparatuses, and non-transitory computer-readable medium described herein may further include operations, features, means, or instructions for determining that the second grant may be a second downlink grant, identifying that the first channel state information and the second channel state information may be associated with a second aperiodic channel state information type, and determining, based on the identifying, a first acknowledgement associated with the downlink grant and a second acknowledgement associated with the second downlink grant.

In some examples of the method, apparatuses, and non-transitory computer-readable medium described herein, determining the transmission order associated with the first channel state information and the second channel state information may include operations, features, means, or instructions for determining a starting symbol associated with a transmission of the first channel state information, where the configuration indicates that the second acknowledgement may be to be transmitted no earlier than the starting symbol associated with the transmission of the first channel state information.

In some examples of the method, apparatuses, and non-transitory computer-readable medium described herein, determining the transmission order associated with the first channel state information and the second channel state information may include operations, features, means, or instructions for determining an ending symbol associated with a transmission of the first channel state information, where the configuration indicates that the second acknowledgement may be to be transmitted no earlier than the ending symbol associated with the transmission of the first channel state information.

In some examples of the method, apparatuses, and non-transitory computer-readable medium described herein, the configuration indicates that the first channel state information may be to be transmitted no later than the second channel state information. In some examples of the method, apparatuses, and non-transitory computer-readable medium described herein, the first channel state information and the second channel state information may be transmitted in the same slot.

In some examples of the method, apparatuses, and non-transitory computer-readable medium described herein, determining the transmission order associated with the first channel state information and the second channel state information may include operations, features, means, or instructions for determining a starting symbol associated with a transmission of the first channel state information, where the configuration indicates that the second channel state information may be to be transmitted no earlier than the starting symbol associated with the transmission of the first channel state information.

In some examples of the method, apparatuses, and non-transitory computer-readable medium described herein, determining the transmission order associated with the first channel state information and the second channel state information may include operations, features, means, or instructions for determining an ending symbol associated with a transmission of the first channel state information, where the configuration indicates that the second channel state information may be to be transmitted no earlier than the ending symbol associated with the transmission of the first channel state information.

In some examples of the method, apparatuses, and non-transitory computer-readable medium described herein, the configuration indicates that the first channel state information may be to be transmitted in a first slot and the second channel state information may be to be transmitted in a second slot, the first slot being no later than the second slot. In some examples of the method, apparatuses, and non-transitory computer-readable medium described herein, the configuration indicates that the second acknowledgement associated with the second downlink grant may be allowed to be scheduled earlier than the first channel state information.

Some examples of the method, apparatuses, and non-transitory computer-readable medium described herein may further include operations, features, means, or instructions for determining that the second grant may be a second downlink grant, and receiving a first channel state information reference signal associated with the downlink grant and a second channel state information reference signal associated with the second downlink grant.

In some examples of the method, apparatuses, and non-transitory computer-readable medium described herein, the configuration indicates that the first channel state information reference signal may be allowed to be received earlier than the second channel state information reference signal. In some examples of the method, apparatuses, and non-transitory computer-readable medium described herein, the configuration indicates that the first channel state information may be allowed to be transmitted earlier than the reception of the second channel state information reference signal.

In some examples of the method, apparatuses, and non-transitory computer-readable medium described herein, the configuration indicates that the second channel state information reference signal may be allowed to be received earlier than the transmission of the first channel state information.

Some examples of the method, apparatuses, and non-transitory computer-readable medium described herein may further include operations, features, means, or instructions for receiving an uplink grant including an indication to report a third channel state information, where the uplink grant may be received prior to the downlink grant, and where transmitting the first channel state information includes transmitting the first channel state information prior to transmitting the third channel state information.

Some examples of the method, apparatuses, and non-transitory computer-readable medium described herein may further include operations, features, means, or instructions for receiving an uplink grant including an indication to report a third channel state information, where the uplink grant may be received prior to the downlink grant, and where the configuration indicates that the first channel state information may be allowed to be transmitted no earlier than the third channel state information.

Some examples of the method, apparatuses, and non-transitory computer-readable medium described herein may further include operations, features, means, or instructions for receiving a third grant including an indication to report a third channel state information, determining that the first channel state information and the third channel state information may be associated with the same channel state information report configuration, and refraining from transmitting the third channel state information based on determining that the first channel state information and the third channel state information may be associated with the same channel state information report configuration.

Some examples of the method, apparatuses, and non-transitory computer-readable medium described herein may further include operations, features, means, or instructions for receiving an uplink grant including an indication to report a third channel state information, where the uplink grant may be received prior to the downlink grant, determining that a timeline associated with the downlink grant may be less than a timeline associated with the uplink grant, and transmitting the first channel state information prior to transmitting the third channel state information based on determining that the timeline associated with the downlink grant may be less than the timeline associated with the uplink grant.

Some examples of the method, apparatuses, and non-transitory computer-readable medium described herein may further include operations, features, means, or instructions for determining that the second grant may be an uplink grant, where the configuration indicates that the first channel state information may be allowed to be transmitted earlier than the second channel state information. In some examples of the method, apparatuses, and non-transitory computer-readable medium described herein, transmitting the second channel state information may include operations, features, means, or instructions for transmitting the second channel state information using a physical uplink shared channel.

In some examples of the method, apparatuses, and non-transitory computer-readable medium described herein, transmitting the first channel state information may include operations, features, means, or instructions for transmitting the first channel state information using a physical uplink control channel. In some examples of the method, apparatuses, and non-transitory computer-readable medium described herein, the first channel state information and the second channel state information each include an aperiodic channel state information.

A method of wireless communication at a base station is described. The method may include determining a configuration for a transmission order associated with a first channel state information and a second channel state information, transmitting, to a UE, the configuration indicating the transmission order, transmitting a downlink grant including an indication to report the first channel state information, transmitting a second grant including an indication to report the second channel state information, where the second grant is transmitted after the downlink grant, and receiving the first channel state information and the second channel state information according to the transmission order.

An apparatus for wireless communication at a base station is described. The apparatus may include a processor, memory coupled with the processor, and instructions stored in the memory. The instructions may be executable by the processor to cause the apparatus to determine a configuration for a transmission order associated with a first channel state information and a second channel state information, transmit, to a UE, the configuration indicating the transmission order, transmit a downlink grant including an indication to report the first channel state information, transmit a second grant including an indication to report the second channel state information, where the second grant is transmitted after the downlink grant, and receive the first channel state information and the second channel state information according to the transmission order.

Another apparatus for wireless communication at a base station is described. The apparatus may include means for determining a configuration for a transmission order associated with a first channel state information and a second channel state information, transmitting, to a UE, the configuration indicating the transmission order, transmitting a downlink grant including an indication to report the first channel state information, transmitting a second grant including an indication to report the second channel state information, where the second grant is transmitted after the downlink grant, and receiving the first channel state information and the second channel state information according to the transmission order.

A non-transitory computer-readable medium storing code for wireless communication at a base station is described. The code may include instructions executable by a processor to determine a configuration for a transmission order associated with a first channel state information and a second channel state information, transmit, to a UE, the configuration indicating the transmission order, transmit a downlink grant including an indication to report the first channel state information, transmit a second grant including an indication to report the second channel state information, where the second grant is transmitted after the downlink grant, and receive the first channel state information and the second channel state information according to the transmission order.

Some examples of the method, apparatuses, and non-transitory computer-readable medium described herein may further include operations, features, means, or instructions for receiving, from the UE, UE capability information indicating a capability of the UE to support the transmission order, where determining the configuration may be based on the UE capability information.

Some examples of the method, apparatuses, and non-transitory computer-readable medium described herein may further include operations, features, means, or instructions for determining that the second grant may be a second downlink grant, and identifying that the first channel state information and the second channel state information may be associated with a first aperiodic channel state information type.

In some examples of the method, apparatuses, and non-transitory computer-readable medium described herein, the configuration indicates that the first channel state information and a first acknowledgement associated with the downlink grant may be to be transmitted in a first slot and the second channel state information and a second acknowledgement associated with the second downlink grant may be to be transmitted in a second slot, the first slot being no later than the second slot.

Some examples of the method, apparatuses, and non-transitory computer-readable medium described herein may further include operations, features, means, or instructions for determining that the second grant may be a second downlink grant, and identifying that the first channel state information and the second channel state information may be associated with a second aperiodic channel state information type. In some examples of the method, apparatuses, and non-transitory computer-readable medium described herein, the configuration indicates that a second acknowledgement associated with the second downlink grant may be to be transmitted no earlier than a starting symbol associated with a transmission of the first channel state information.

In some examples of the method, apparatuses, and non-transitory computer-readable medium described herein, the configuration indicates that a second acknowledgement associated with the second downlink grant may be to be transmitted no earlier than an ending symbol associated with a transmission of the first channel state information.

In some examples of the method, apparatuses, and non-transitory computer-readable medium described herein, the configuration indicates that the first channel state information may be to be transmitted no later than the second channel state information. In some examples of the method, apparatuses, and non-transitory computer-readable medium described herein, the first channel state information and the second channel state information may be received in the same slot.

In some examples of the method, apparatuses, and non-transitory computer-readable medium described herein, the configuration indicates that the second channel state information may be to be transmitted no earlier than a starting symbol associated with a transmission of the first channel state information.

In some examples of the method, apparatuses, and non-transitory computer-readable medium described herein, the configuration indicates that the second channel state information may be to be transmitted no earlier than an ending symbol associated with a transmission of the first channel state information. In some examples of the method, apparatuses, and non-transitory computer-readable medium described herein, the configuration indicates that the first channel state information may be to be transmitted in a first slot and the second channel state information may be to be transmitted in a second slot, the first slot being no later than the second slot.

In some examples of the method, apparatuses, and non-transitory computer-readable medium described herein, the configuration indicates that a second acknowledgement associated with the second downlink grant may be allowed to be scheduled earlier than the first channel state information. Some examples of the method, apparatuses, and non-transitory computer-readable medium described herein may further include operations, features, means, or instructions for determining that the second grant may be a second downlink grant, and transmitting a first channel state information reference signal associated with the downlink grant and a second channel state information reference signal associated with the second downlink grant.

In some examples of the method, apparatuses, and non-transitory computer-readable medium described herein, the configuration indicates that the first channel state information reference signal may be allowed to be received earlier than the second channel state information reference signal. In some examples of the method, apparatuses, and non-transitory computer-readable medium described herein, the configuration indicates that the first channel state information may be allowed to be transmitted earlier than the reception of the second channel state information reference signal.

In some examples of the method, apparatuses, and non-transitory computer-readable medium described herein, the configuration indicates that the second channel state information reference signal may be allowed to be received earlier than the transmission of the first channel state information. Some examples of the method, apparatuses, and non-transitory computer-readable medium described herein may further include operations, features, means, or instructions for transmitting an uplink grant including an indication to report a third channel state information, where the uplink grant may be transmitted prior to the downlink grant, and where receiving the first channel state information includes receiving the first channel state information prior to receiving the third channel state information.

Some examples of the method, apparatuses, and non-transitory computer-readable medium described herein may further include operations, features, means, or instructions for transmitting an uplink grant including an indication to report a third channel state information, where the uplink grant may be transmitted prior to the downlink grant, and where the configuration indicates that the first channel state information may be allowed to be transmitted no earlier than the third channel state information.

Some examples of the method, apparatuses, and non-transitory computer-readable medium described herein may further include operations, features, means, or instructions for transmitting an uplink grant including an indication to report a third channel state information, where the uplink grant may be transmitted prior to the downlink grant, and receiving the first channel state information prior to receiving the third channel state information based on a timeline associated with the downlink grant being less than a timeline associated with the uplink grant.

Some examples of the method, apparatuses, and non-transitory computer-readable medium described herein may further include operations, features, means, or instructions for determining that the second grant may be an uplink grant, where the configuration indicates that the first channel state information may be allowed to be transmitted earlier than the second channel state information. In some examples of the method, apparatuses, and non-transitory computer-readable medium described herein, receiving the second channel state information may include operations, features, means, or instructions for receiving the second channel state information using a physical uplink shared channel.

In some examples of the method, apparatuses, and non-transitory computer-readable medium described herein, receiving the first channel state information may include operations, features, means, or instructions for receiving the first channel state information using a physical uplink control channel. In some examples of the method, apparatuses, and non-transitory computer-readable medium described herein, the first channel state information and the second channel state information each include an aperiodic channel state information.

### BRIEF DESCRIPTION OF THE DRAWINGS

FIG. 1 illustrates an example of a wireless communications system that supports transmission order determination for aperiodic channel state information in accordance with aspects of the present disclosure.

FIG. 2 illustrates an example of a wireless communications system that supports transmission order determination for aperiodic channel state information in accordance with aspects of the present disclosure.

FIG. 3 illustrates an example of a configuration that supports transmission order determination for aperiodic channel state information in accordance with aspects of the present disclosure.

FIG. 4 illustrates an example of a configuration that supports transmission order determination for aperiodic channel state information in accordance with aspects of the present disclosure.

FIG. 5 illustrates an example of a configuration that supports transmission order determination for aperiodic channel state information in accordance with aspects of the present disclosure.

FIGS. 6A and 6B illustrate examples of configurations that support transmission order determination for aperiodic channel state information in accordance with aspects of the present disclosure.

FIGS. 7A and 7B illustrate examples of configurations that support transmission order determination for aperiodic channel state information in accordance with aspects of the present disclosure.

FIGS. 8 and 9 show block diagrams of devices that support transmission order determination for aperiodic channel state information in accordance with aspects of the present disclosure.

FIG. 10 shows a block diagram of a communications manager that supports transmission order determination for aperiodic channel state information in accordance with aspects of the present disclosure.

FIG. 11 shows a diagram of a system including a device that supports transmission order determination for aperiodic channel state information in accordance with aspects of the present disclosure.

FIGS. 12 and 13 show block diagrams of devices that support transmission order determination for aperiodic channel state information in accordance with aspects of the present disclosure.

FIG. 14 shows a block diagram of a communications manager that supports transmission order determination for aperiodic channel state information in accordance with aspects of the present disclosure.

FIG. 15 shows a diagram of a system including a device that supports transmission order determination for aperiodic channel state information in accordance with aspects of the present disclosure.

FIGS. 16 through 19 show flowcharts illustrating methods that support transmission order determination for aperiodic channel state information in accordance with aspects of the present disclosure.

### DETAILED DESCRIPTION

Some wireless communication systems may include communication devices, such as user equipments (UEs) and base stations, for example, eNodeBs (eNBs), next-generation NodeBs or giga-NodeBs (either of which may be referred to as a gNB) that may support multiple radio access technologies. Examples of radio access technologies include 4G systems such as Long Term Evolution (LTE) systems and fifth generation (5G) systems which may be referred to as New Radio (NR) systems. The communication devices may, in some examples, support one or more of the above example radio access technologies. Channel state information resources may be measured by a UE to estimate channel quality between a base station and UE, where the channel quality may be indicated by measured parameters (e.g., channel quality indicator, precoding matrix indicator, rank indicator, layer one reference signal received power). The UE may transmit a channel state information report to the base station indicating the channel quality information that the base station may use for data transmissions. The base station may use this report for scheduling in the future. Conventional channel state information reporting techniques may however, be deficient.

In existing wireless communications systems, a transmission order associated with multiple acknowledgements may be specified for a UE and a base station. Specifically, a UE may receive a first downlink grant and may determine a first acknowledgement associated with the first downlink grant. The UE may then additionally receive a second downlink grant and may determine a second acknowledgement associated with the second downlink grant. In some cases, the UE may determine the first acknowledgement after receiving the second downlink grant. In some wireless communication systems, the UE may identify a configuration indicating a transmission order associated with the first acknowledgement and the second acknowledgement. For example, the UE may determine that the second acknowledgement associated with the second downlink grant may not be transmitted in a slot or sub-slot that is earlier than a slot for transmitting the first acknowledgement associated with the first downlink grant. Current wireless communications systems may allow a downlink grant to trigger an aperiodic channel state information report on physical uplink control channel. Thus, there exists a need for order definition for multiple aperiodic channel state information triggered by multiple grants, among other conditions.

One or more aspects of the present disclosure address, among other aspects, implementing one or more rules to efficiently define an ordering for multiple aperiodic channel state information reports triggered by multiple downlink or downlink and uplink grants. In some examples, a UE may receive a first downlink grant triggering a first aperiodic channel state information report. The UE may also receive a second downlink grant triggering a second aperiodic channel state information report. In some cases, the UE may receive the first grant prior to receiving the second grant. The UE may determine a transmission order according to a rule (such as a configuration received from the base station or a preconfigured rule), and may then transmit the first aperiodic channel state information report and the second aperiodic channel state information report according to the transmission order.

Aspects of the disclosure are initially described in the context of a wireless communications system. Aspects of the disclosure are further illustrated by and described with reference to apparatus diagrams, system diagrams, and flowcharts that relate to transmission order determination for aperiodic channel state information.

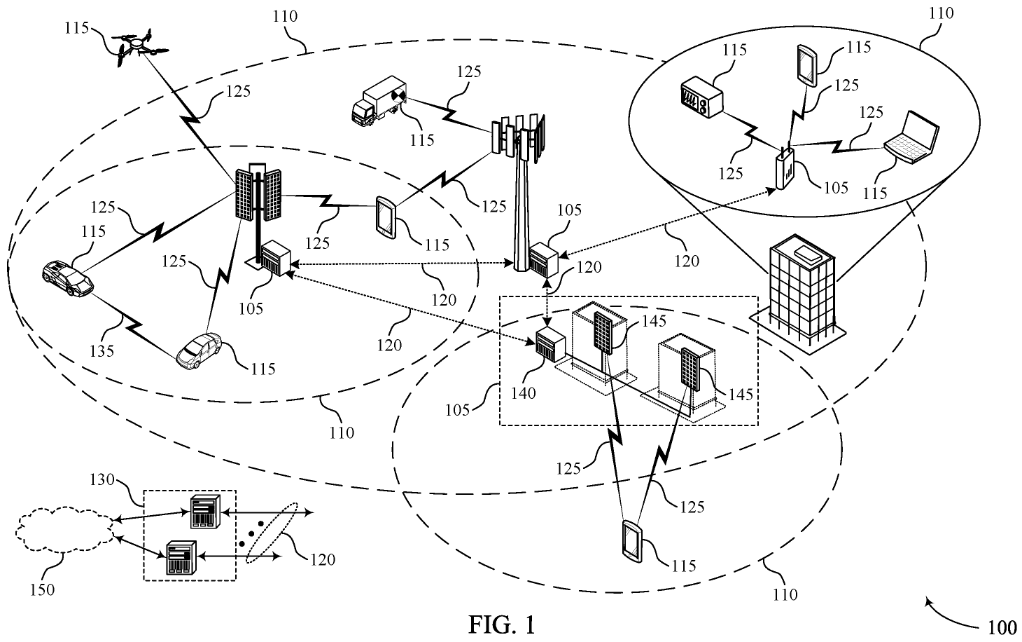

FIG. 1 illustrates an example of a wireless communications system 100 that supports transmission order determination for aperiodic channel state information in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may be a device such as a cellular phone, a smart phone, a personal digital assistant (PDA), a multimedia/entertainment device (e.g., a radio, a MP3 player, a video device, etc.), a camera, a gaming device, a navigation/positioning device (e.g., GNSS (global navigation satellite system) devices based on, for example, GPS (global positioning system), Beidou, GLONASS, or Galileo, a terrestrial-based device, etc.), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may also refer to a wireless local loop (WLL) station, an Internet of Things (IoT) device, an Internet of Everything (IoE) device, or an MTC device, or the like, which may be implemented in various articles such as appliances, drones, robots, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFTS-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some wireless communications systems, a transmission order associated with multiple acknowledgements may be statically specified for a UE and a base station. In some cases, the UE may identify a configuration indicating a transmission order associated with a first acknowledgement associated with a first downlink grant and a second acknowledgement associated with a second downlink grant. The transmission order may indicate that the second acknowledgement associated with the second downlink grant may not be transmitted in a slot or sub-slot that is earlier than a slot for transmitting the first acknowledgement associated with the first downlink grant. Such wireless communications systems may allow a downlink grant to trigger an aperiodic channel state information report on physical uplink control channel. Thus, there exists a need for order definition for multiple aperiodic channel state information triggered by multiple grants, among other conditions.

One or more aspects of the present disclosure address, among other aspects, implementing one or more rules to efficiently define an ordering for multiple aperiodic channel state information reports triggered by multiple downlink or downlink and uplink grants. In some examples, a UE 115 may receive a first downlink grant triggering a first aperiodic channel state information report and a second downlink grant triggering a second aperiodic channel state information report. The UE 115 may determine a transmission order according to a configuration received from the base station 105. The UE 115 may then transmit the first aperiodic channel state information report and the second aperiodic channel state information report according to the transmission order.

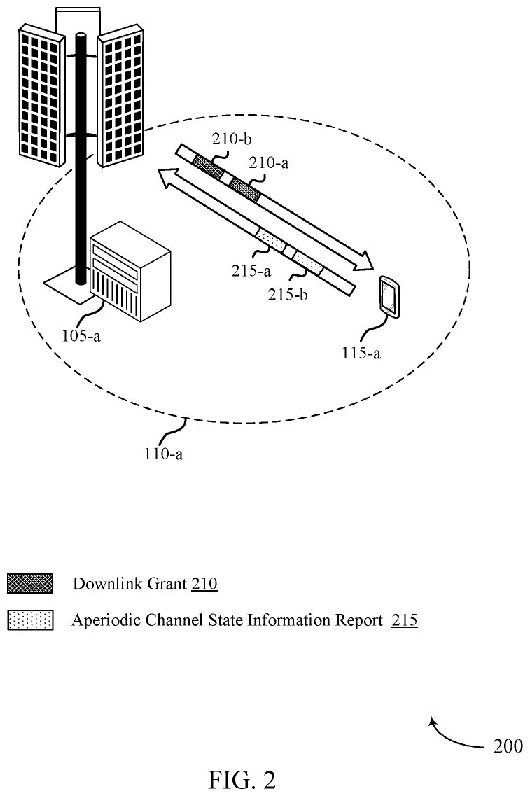

FIG. 2 illustrates an example of a wireless communications system 200 that supports transmission order determination for aperiodic channel state information in accordance with aspects of the present disclosure. In some examples, the wireless communications system 200 may implement aspects of wireless communications system 100. The wireless communications system 200 may include a base station 105-a and a UE 115-a within a geographic coverage area 110-a. The base station 105-a and the UE 115-a may be examples of base stations 105 and UEs 115 as described herein. In some examples, the wireless communications system 200 may support multiple radio access technologies including 4G systems such as LTE systems, LTE-A systems, or LTE-A Pro systems, and 5G systems which may be referred to as NR systems or NR communications systems. In some examples, the wireless communications system 200 may implement aspects of the wireless communications system 100 to support improvements to power consumption, spectral efficiency, higher data rates and, in some examples, may promote enhanced efficiency for high reliability and low latency communication operations, among other benefits.

According to one or more aspects of the present disclosure, the UE 115-a may implement one or more rules to efficiently define an ordering for multiple aperiodic channel state information reports triggered by multiple downlink grants. For example, the UE 115-a may be configured by the base station 105-a to implement the one or more rules, and the UE 115-a may implement the one or more rules to a transmission order for the channel state information reports. In some cases, the UE 115-a may identify the one or more rules from a predefined configuration (such as a configuration defined for multiple UEs), and may implement the one or more rules to identify the transmission order for multiple aperiodic channel state information reports. Additionally or alternatively, other wireless devices, such as the base station 105-a, may implement the one or more rules described herein for improved efficiency and data throughput for system communications, among other benefits.

The base station 105-a may transmit a channel state information reference signal within one or more channel state information resources for measurement by a UE 115-a to estimate channel quality between the base station 105-a and the UE 115-a. The UE 115-a may transmit a channel state information report to the base station indicating the channel quality information that the base station 105 may use, for example, for scheduling subsequent data transmissions.

In some wireless communications systems, a channel state information report may be requested by a base station using downlink grants. For instance, a UE (such as UE 115-a) may receive a downlink grant and may further receive one or more downlink control information messages (e.g., in a physical downlink shared channel, physical downlink control channel, etc.), where each downlink control information message may include an associated physical uplink shared channel for transmitting uplink messages scheduled by the downlink control information message. In one or more wireless communications systems, the UE may determine an acknowledgement associated with the downlink grant. In some aspects, the acknowledgement reporting may be associated with a timeline. That is, a UE may receive a downlink grant and may determine an offset (e.g., K0=0 or K0=a non-zero value) which may indicate a gap between the downlink grant and a physical downlink shared channel. Additionally or alternatively, the UE may determine a second offset (K1) which may indicate to the UE when an acknowledgement or negative acknowledgement associated with the physical downlink shared channel is to be reported to the base station.

In some examples, the base station may use the reported acknowledgement or negative acknowledgement to perform link adaptation, among other operations. In existing wireless communications systems, an order associated with multiple acknowledgements or negative acknowledgements may be specified for a UE and a base station. Specifically, a UE may receive a first downlink grant and may determine a first acknowledgement (e.g., HARQ-ACK) associated with the first downlink grant. The UE may then receive a second downlink grant and may determine a second acknowledgement associated with the second downlink grant. According to existing configurations, the UE may determine that the second acknowledgement associated with the second downlink grant may not be transmitted in a slot or sub-slot that is earlier than a slot for the first acknowledgement associated with the first downlink grant. In some examples, the first acknowledgement associated with the first downlink grant and the second acknowledgement associated with the second downlink grant may be scheduled in the same slot. If the first acknowledgement associated with the first downlink grant and the second acknowledgement associated with the second downlink grant are scheduled in the same slot, the UE may multiplex the first acknowledgement and the second acknowledgement in one physical uplink control channel.

Additionally or alternatively, a UE (such as UE 115-a) may receive multiple uplink grants, and may identify an associated physical uplink shared channel for transmitting uplink messages scheduled by the uplink grants. In some examples, a UE may measure a channel state and may transmit a channel state information report. According to one or more aspects, the channel state information may be included in a physical uplink shared channel for example, as semi-static reporting. In some examples, an order associated with multiple physical uplink shared channels may be specified for a UE and a base station. For example, a UE may receive a first uplink grant and may identify a first physical uplink shared channel associated with the first uplink grant. The UE may then receive a second uplink grant after receiving the first uplink grant. The UE may identify a second physical uplink shared channel associated with the second uplink grant. In some aspects, the UE and the base station may be configured such that the second physical uplink shared channel scheduled by the second uplink grant (i.e., the uplink grant received later in time) cannot start prior to the ending symbol of the first physical uplink shared channel scheduled by first uplink grant.

In some wireless communications systems, channel state information or channel quality indicator information feedback may be based on a periodic channel state information feedback or an aperiodic channel state information feedback. In some examples, the periodic channel state information feedback may not be flexible and may be associated with a periodicity value. Additionally or alternatively, a timeline associated with the aperiodic channel state information feedback may be different from a timeline associated with acknowledgement or negative acknowledgement transmission. That is, a UE may not transmit an aperiodic channel state information in the same slot as an acknowledgement. In some examples, channel state information may be included in a channel state information report. Current wireless communications systems supporting NR communications may provide for a downlink grant to trigger an aperiodic channel state information report on physical uplink control channel. In some examples, a UE may receive multiple downlink grants triggering multiple aperiodic channel state information reports. Thus, there exists a need for an order definition for different aperiodic channel state information reports on PUCCH physical uplink control channel triggered by multiple downlink grants.

According to one or more aspects of the present disclosure, a UE 115-a may receive (such as from the base station 105-a) a first downlink grant 210-a triggering a first aperiodic channel state information report 215-a and a second downlink grant 210-b triggering a second aperiodic channel state information report 215-b. As depicted in the example of FIG. 2, the UE 115-a may receive the second downlink grant 210-b after receiving first downlink grant 210-a. In some aspects, the UE 115-a may determine a transmission order according to a rule (such as a configuration transmitted by the base station 105-a or otherwise identified by the UE 115-a). The rule may be based on a UE capability. For example, the UE 115-a may transmit UE capability information indicating a capability of the UE 115-a to support the transmission order. That is, the UE 115-a may indicate to the base station 105-a, that the UE 115-a may support out-of-order transmissions. Based on the UE capability information, the base station 105-a may identify the one or more rules and may include the one or more rules in a configuration message. The UE 115-a may receive the configuration message from the base station 105-a and may identify a transmission order for transmitting multiple aperiodic channel state information reports. In some cases, the channel state information reports may include channel state information. In some examples, the transmission order may define whether out-of-order transmission of aperiodic channel state information reports is possible for the UE 115-a. Upon determining the transmission order, the UE 115-a may transmit the first aperiodic channel state information report 215-a and the second aperiodic channel state information report 215-b according to the transmission order. As depicted in the example of FIG. 2, the UE 115-a may determine that out-of-order transmission of aperiodic channel state information reports is not allowed for the UE 115-a. In such a case, the UE 115-a may transmit the first aperiodic channel state information report 215-a prior to transmitting the second aperiodic channel state information report 215-b.

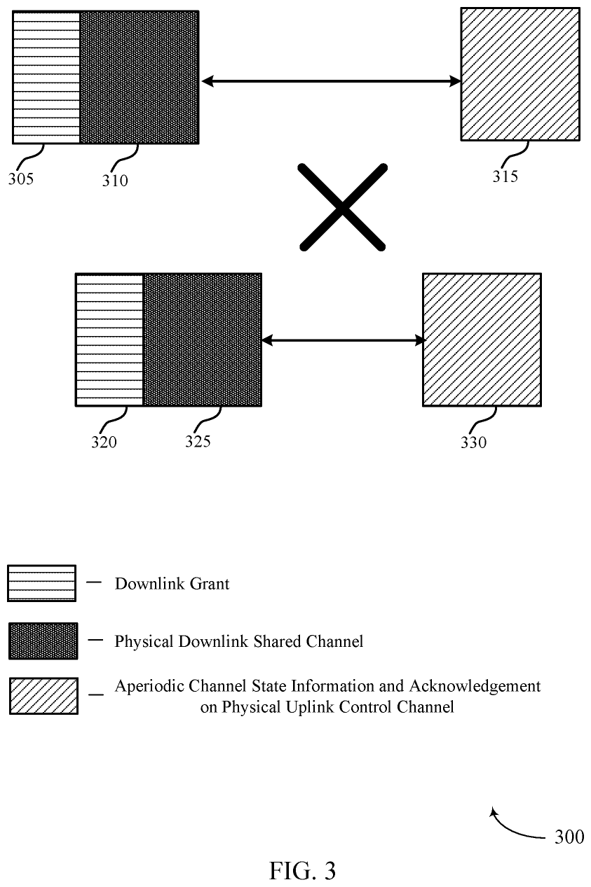

FIG. 3 illustrates an example of a configuration 300 that supports transmission order determination for aperiodic channel state information in accordance with aspects of the present disclosure. In some examples, the configuration 300 may implement aspects of wireless communications system 100 as described with reference to FIG. 1 and the wireless communications system 200 as described with reference to FIG. 2. The configuration 300 may be an example of a UE transmitting a first type of aperiodic channel state information (e.g., type 1 aperiodic channel state information). In the example of FIG. 3, the configuration 300 illustrates procedures for communicating according to a configuration to facilitate a transmission order for multiple aperiodic channel state information (such as aperiodic channel state information reports) in response to multiple downlink grants received at a UE from a base station, which may be examples of the corresponding devices as described with reference to FIG. 1.

In some aspects, a first type of aperiodic channel state information may include transmission of a joint channel state information (such as aperiodic channel state information) and an acknowledgement report on a physical uplink control channel. For example, a UE (such as UE 115) may receive a downlink grant and the UE may identify that the downlink grant triggers an aperiodic channel state information report. The UE may determine an acknowledgement associated with the downlink grant, and may jointly transmit the aperiodic channel state information report and the acknowledgement in a physical uplink control channel. According to one or more aspects of the present disclosure, in case of a type 1 aperiodic channel state information transmission, the UE may not be expected to report a joint acknowledgement and aperiodic channel state information report triggered by a later downlink grant in a slot j<i, if the UE was previously scheduled by a prior downlink grant to transmit a joint acknowledgement and aperiodic channel state information report on slot i.

As depicted in the example of FIG. 3, the UE may receive a first downlink grant 305 including an indication to report a first channel state information and may receive a second downlink grant 320 including an indication to report a second channel state information. In this example, the UE may receive the second downlink grant 320 after the first downlink grant 305. The UE may identify a first physical downlink shared channel 310 associated with the first downlink grant 305 and a second physical downlink shared channel 325 associated with the second downlink grant 320. In some examples, the UE may identify that the first channel state information and the second channel state information are associated with a first aperiodic channel state information type (or type 1 aperiodic channel state information transmission). Based on receiving the first physical downlink shared channel 310 associated with the first downlink grant 305, the UE may identify a first acknowledgement. Additionally, the UE may identify a second acknowledgement based on the second physical downlink shared channel 325 associated with the second downlink grant 320. According to one or more aspects of the present disclosure, the UE may determine a transmission order based on a configuration received from a base station or otherwise determined by the UE. In some examples, the transmission order may be associated with a joint transmission 315 of the first aperiodic channel state information and the first acknowledgement and a joint transmission 330 of the second aperiodic channel state information and the second acknowledgement.

In some examples, the configuration may indicate that the first aperiodic channel state information and the first acknowledgement (i.e., joint transmission 315) is to be transmitted in a first slot and the second aperiodic channel state information and the second acknowledgement (i.e., joint transmission 330) is to be transmitted in a second slot, the first slot being no later than the second slot. Thus, as depicted in the example of FIG. 3, the UE may determine that the joint transmission 315 of the first aperiodic channel state information and the first acknowledgement being later (e.g., in a later slot) than the joint transmission 330 of the second aperiodic channel state information and the second acknowledgement is not allowed for the UE. That is, the UE may determine that the configuration may not allow the UE to transmit the second aperiodic channel state information and the second acknowledgement prior to the first aperiodic channel state information and the first acknowledgement. In some examples, the UE may transmit the first aperiodic channel state information and the second aperiodic channel state information according to the transmission order.

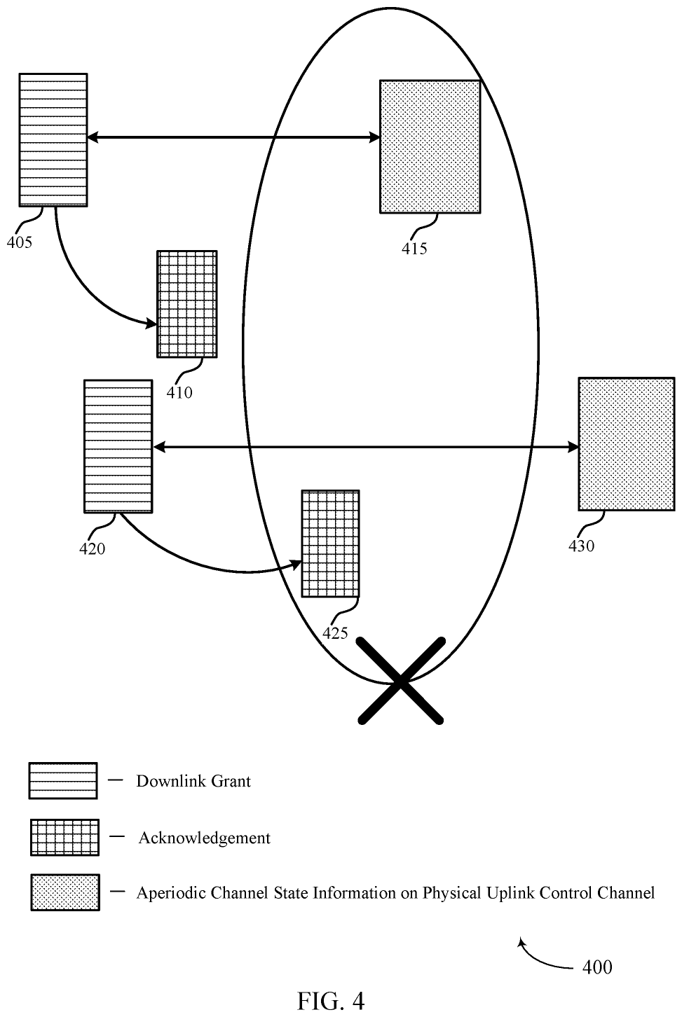

FIG. 4 illustrates an example of a configuration 400 that supports transmission order determination for aperiodic channel state information in accordance with aspects of the present disclosure. In some examples, the configuration 400 may implement aspects of wireless communications system 100 as described with reference to FIG. 1 and the wireless communications system 200 as described with reference to FIG. 2. The configuration 400 may be an example of a UE transmitting a second type of aperiodic channel state information (e.g., type 2 aperiodic channel state information). In the example of FIG. 4, the configuration 400 illustrates procedures for communicating according to a configuration to facilitate a transmission order for multiple aperiodic channel state information (such as aperiodic channel state information reports) in response to multiple downlink grants received at a UE from a base station, which may be examples of the corresponding devices as described with reference to FIG. 1.

In some aspects, a second type of aperiodic channel state information may include separate transmission of channel state information (such as aperiodic channel state information) and an acknowledgement report on separate physical uplink control channels. In some examples, a UE (such as UE 115) may receive a downlink grant and the UE may identify that the downlink grant triggers an aperiodic channel state information report. The UE may determine an acknowledgement associated with the downlink grant. The UE may transmit the acknowledgement in a first physical uplink control channel and the aperiodic channel state information report in a second physical uplink control channel. That is, a UE configured with a second type of aperiodic channel state information may transmit separate acknowledgement (e.g., HARQ-ACK) and channel state information report on corresponding physical uplink control channels.

According to one or more aspects of the present disclosure, in case of a type 2 aperiodic channel state information transmission, an acknowledgement and an aperiodic channel state information triggered by one or more downlink grants may follow the same order. In some examples, the UE (such as UE 115) may receive a first downlink grant 405 including an indication to report a first channel state information 415. The UE may further receive a second downlink grant 420 including an indication to report a second channel state information 430. As depicted in the example of FIG. 4, the UE may receive the second downlink grant 420 after the first downlink grant 405. The UE may identify a first acknowledgement 410 associated with the first downlink grant 405 and a second acknowledgement 425 associated with the second downlink grant 420. In some examples, the UE may identify that the first channel state information 415 and the second channel state information 430 are associated with a second aperiodic channel state information type (or type 2 aperiodic channel state information transmission). In some examples, the UE may determine a transmission order based on a configuration received from a base station or otherwise determined by the UE. The configuration may indicate that the second acknowledgement 425 triggered by the second downlink grant 420 is allowed to be transmitted after the starting symbol or the ending symbol of the first channel state information 415 triggered by the first downlink grant 405.

In some examples, the UE may determine a starting symbol associated with a transmission of the first channel state information 415. In some cases, the configuration may indicate that the second acknowledgement 425 is to be transmitted no earlier than the starting symbol associated with the transmission of the first channel state information 415. Additionally or alternatively, the UE may determine an ending symbol associated with a transmission of the first channel state information 415. In such cases, the configuration may indicate that the second acknowledgement 425 is to be transmitted no earlier than the ending symbol associated with the transmission of the first channel state information 415. Thus, as depicted in the example of FIG. 4, the configuration may not allow the UE to transmit the second acknowledgement 425 before transmitting the first channel state information 415.

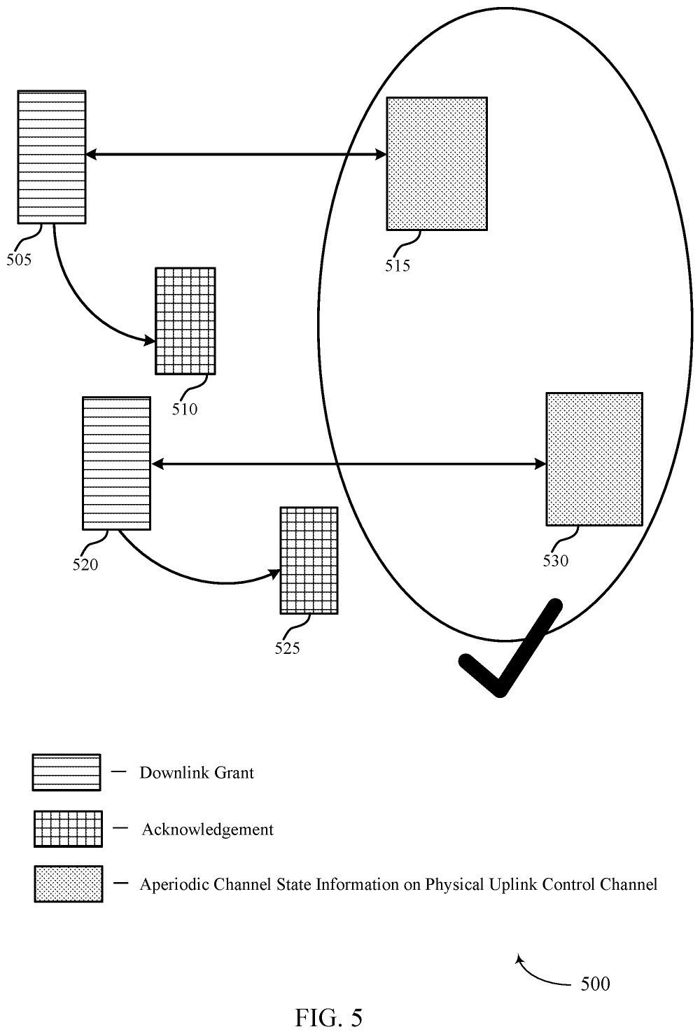

FIG. 5 illustrates an example of a configuration 500 that supports transmission order determination for aperiodic channel state information in accordance with aspects of the present disclosure. In some examples, the configuration 500 may implement aspects of wireless communications system 100 as described with reference to FIG. 1 and the wireless communications system 200 as described with reference to FIG. 2. The configuration 500 may be an example of a UE transmitting a second type of aperiodic channel state information (e.g., type 2 aperiodic channel state information). In the example of FIG. 5, the configuration 500 illustrates procedures for communicating according to a configuration to facilitate a transmission order for multiple aperiodic channel state information (such as aperiodic channel state information reports) in response to multiple downlink grants received at a UE from a base station, which may be examples of the corresponding devices as described with reference to FIG. 1.

As described herein, a second type of aperiodic channel state information may include separate transmission of channel state information (such as aperiodic channel state information) and an acknowledgement report on separate physical uplink control channels. In some examples, a UE (such as UE 115) may receive a downlink grant and the UE may identify that the downlink grant triggers an aperiodic channel state information report. The UE may determine the aperiodic channel state information report and an acknowledgement associated with the downlink grant. In the example of the type 2 aperiodic channel state information report transmission, the UE may transmit the acknowledgement in a first physical uplink control channel and the aperiodic channel state information report in a second physical uplink control channel.

According to one or more aspects of the present disclosure, in case of a type 2 aperiodic channel state information transmission, one or more acknowledgements and one or more aperiodic channel state information triggered by one or more downlink grants may follow their respective orders. For example, an acknowledgement triggered by a second downlink grant (i.e., a downlink grant received later that a first downlink grant) may not be required to be received later than an aperiodic channel state information transmission triggered by the first downlink grant. That is, a configuration received or otherwise identified by the UE may indicate that for a type 2 aperiodic channel state information transmission, aperiodic channel state information and acknowledgement transmission for different grants may not be in order. However, the configuration may further indicate that the aperiodic channel state information triggered by a later downlink grant may not be transmitted earlier than the aperiodic channel state information triggered by a prior downlink grant.

As described with reference to FIG. 5, the UE (such as UE 115) may receive a first downlink grant 505 including an indication to report a first channel state information 515. The UE may also receive a second downlink grant 520 including an indication to report a second channel state information 530. In some examples, the UE may receive the second downlink grant 520 after the first downlink grant 505. The UE may identify a first acknowledgement 510 associated with the first downlink grant 505 and a second acknowledgement 525 associated with the second downlink grant 520. In some examples, the UE may identify that the first channel state information 515 and the second channel state information 530 are associated with a second aperiodic channel state information type (or type 2 aperiodic channel state information transmission). According to one or more aspects of the present disclosure, the UE may determine a transmission order based on a configuration received from a base station.

The configuration may indicate that the UE is not allowed to schedule the second aperiodic channel state information 530 earlier than the first aperiodic channel state information 515. For example, the configuration may indicate that the first channel state information 515 is to be transmitted no later than the second channel state information 530. In some cases, the first channel state information 515 and the second channel state information 530 are transmitted in the same slot. According to another example, the configuration may indicate that the UE is not allowed to schedule the second aperiodic channel state information 530 starting prior to a starting symbol of the transmission of the first aperiodic channel state information 515. In some examples, the UE may determine a starting symbol associated with a transmission of the first channel state information 515. In some cases, the UE may determine that the configuration indicates that the second channel state information 530 is to be transmitted no earlier than the starting symbol associated with the transmission of the first channel state information 515.

Additionally or alternatively, the configuration may indicate that the UE is not allowed to schedule the second aperiodic channel state information 530 earlier than an ending symbol of the first aperiodic channel state information 515. For example, the UE may determine an ending symbol associated with a transmission of the first channel state information 515. In some cases, the configuration may indicate that the second channel state information 530 is to be transmitted no earlier than the ending symbol associated with the transmission of the first channel state information 515. Additionally or alternatively, the configuration may indicate that the UE is not expected to be scheduled to transmit two aperiodic channel state information reports on physical uplink control channels in the same slot. That is, the configuration may indicate that the second aperiodic channel state information 530 is to be transmitted in a later slot than the first aperiodic channel state information 515. For example, the configuration may indicate that the first channel state information is to be transmitted in a first slot and the second channel state information is to be transmitted in a second slot, the first slot being earlier than the second slot. In some examples, the configuration may indicate that the second acknowledgement 525 associated with the second downlink grant 520 is allowed to be scheduled earlier than the first channel state information 515.

As described in the example of FIG. 5, the UE may determine the transmission order of the first aperiodic channel state information 515 and the second aperiodic channel state information 530, and the UE may transmit the first aperiodic channel state information 515 and the second aperiodic channel state information 530 according to the transmission order.

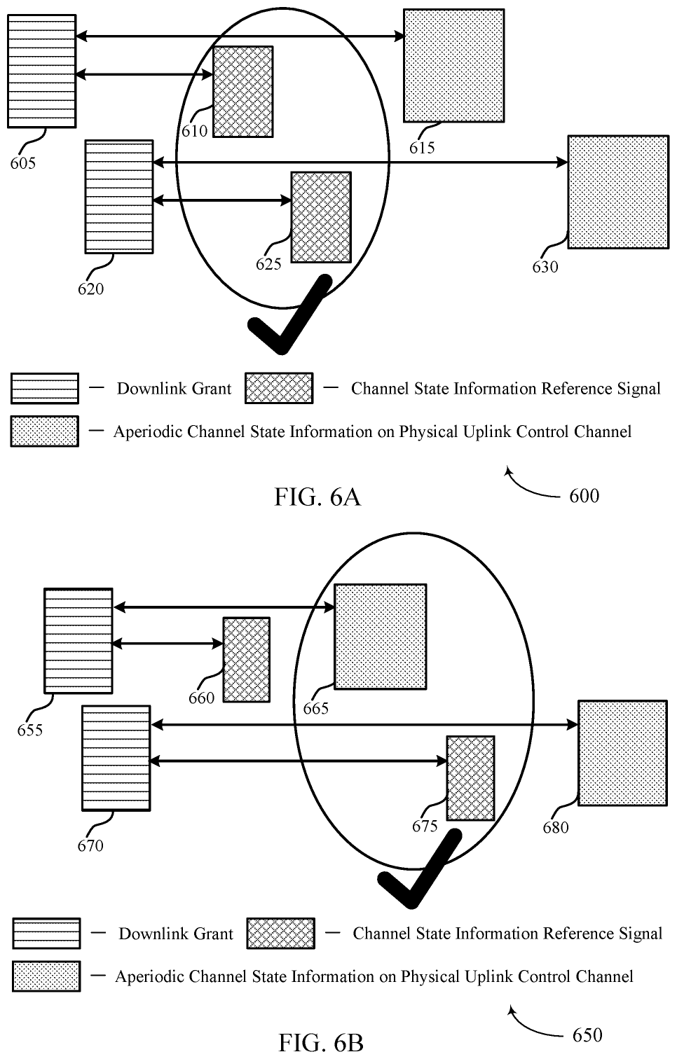

FIGS. 6A and 6B illustrate examples of a configuration 600 and a configuration 650 that supports transmission order determination for aperiodic channel state information in accordance with aspects of the present disclosure. In some examples, the configuration 600 and the configuration 650 may implement aspects of wireless communications system 100 as described with reference to FIG. 1 and the wireless communications system 200 as described with reference to FIG. 2. The configuration 600 and the configuration 650 may be examples of a UE transmitting a second type of aperiodic channel state information (e.g., type 2 aperiodic channel state information). In the example of FIGS. 6A and 6B, the configuration 600 and the configuration 650 may illustrate procedures for communicating according to one or more configuration to facilitate a transmission order for multiple aperiodic channel state information (such as aperiodic channel state information reports) in response to multiple downlink grants received at a UE from a base station, which may be examples of the corresponding devices as described with reference to FIG. 1.

According to one or more aspects of the present disclosure, one or more channel state information reference signals and one or more aperiodic channel state information triggered by one or more downlink grants may follow a transmission order. In the example of FIG. 6A, the UE (such as UE 115) may receive a first downlink grant 605 including an indication to report a first channel state information 615 (such as an aperiodic channel state information). The UE may also receive a second downlink grant 620 including an indication to report a second channel state information 630. In some examples, the UE may receive the second downlink grant 620 after the first downlink grant 605. The UE may also receive a first channel state information reference signal 610 associated with the first downlink grant 605 and a second channel state information reference signal 625 associated with the second downlink grant 620. In some examples, the UE may determine a transmission order based on a configuration received from a base station or otherwise identified by the UE. The configuration may indicate that the channel state information reference signal 625 triggered by the second downlink grant 620 is not allowed to be received earlier than the channel state information reference signal 610 triggered by the first downlink grant 605. The configuration may further indicate that the channel state information reference signal 625 triggered by the second downlink grant 620 may not be in order with the aperiodic channel state information 615 (such as channel state information report) triggered by the first downlink grant 605. For example, the configuration may indicate that the first channel state information reference signal 610 is allowed to be received earlier than the second channel state information reference signal 625. Additionally or alternatively, the configuration may indicate that the first channel state information 615 is allowed to be transmitted earlier than the reception of the second channel state information reference signal 625 (not shown). In some examples, the configuration may indicate that the second channel state information reference signal 625 is allowed to be received earlier than the transmission of the first channel state information 615.

In the example of FIG. 6B, the UE may receive a first downlink grant 655 including an indication to report a first channel state information 665 (such as an aperiodic channel state information). The UE may also receive a second downlink grant 670 including an indication to report a second channel state information 680. In some examples, the UE may receive the second downlink grant 670 after the first downlink grant 655. The UE may receive a first channel state information reference signal 660 associated with the first downlink grant 655 and a second channel state information reference signal 675 associated with the second downlink grant 670. In some examples, the UE may determine a transmission order based on a configuration received from a base station or otherwise identified by the UE. According to one or more aspects of the present disclosure, the configuration may indicate that the second channel state information reference signal 675 triggered by the second downlink grant 670 may not be received earlier than the first channel state information report 665 (or aperiodic channel state information report) report triggered by the first downlink grant 655.

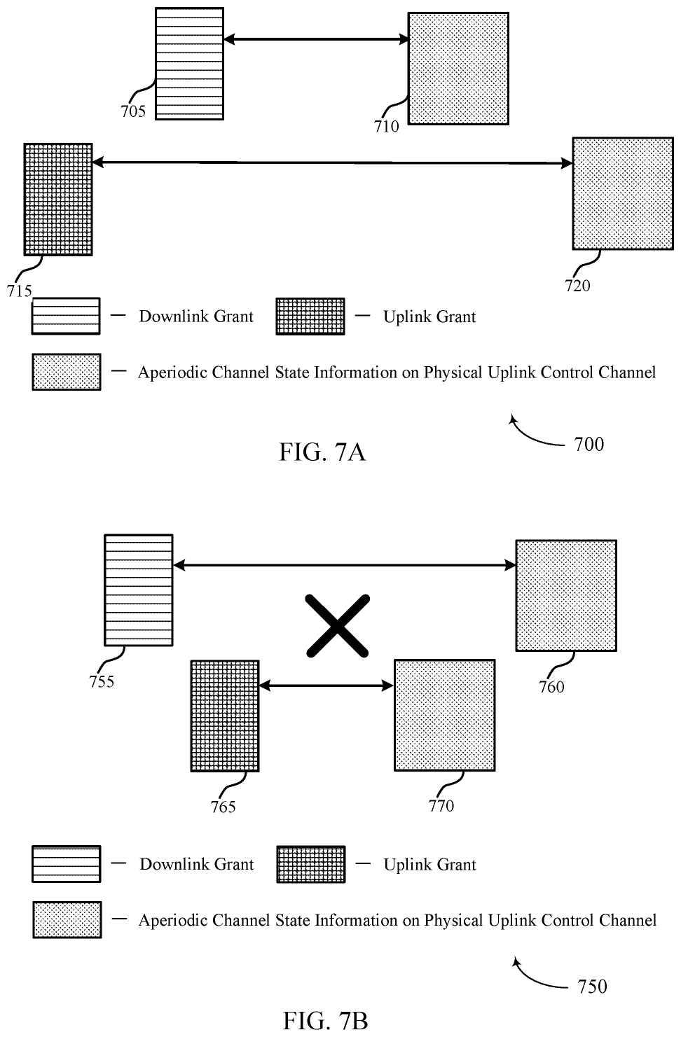

FIGS. 7A and 7B illustrate examples of a configuration 700 ad a configuration 750 that support transmission order determination for aperiodic channel state information in accordance with aspects of the present disclosure. In some examples, the configuration 700 and the configuration 750 may implement aspects of wireless communications system 100 as described with reference to FIG. 1 and the wireless communications system 200 as described with reference to FIG. 2. In the examples of FIGS. 7A and 7B, the configuration 700 and the configuration 750 may illustrate procedures for communicating according to one or more configuration to facilitate a transmission order for multiple aperiodic channel state information (such as aperiodic channel state information reports) in response to multiple downlink grants received at a UE from a base station, which may be examples of the corresponding devices as described with reference to FIG. 1.

In the example of FIG. 7A, the UE (such as UE 115) may receive a downlink grant 705 including an indication to report a first channel state information 710 (such as an aperiodic channel state information). The UE may also receive an uplink grant 715 including an indication to report a second channel state information 720. In some examples, the UE may receive the uplink grant 715 prior to receiving the downlink grant 705. In some examples, the UE may determine a transmission order based on a configuration received from a base station or otherwise identified by the UE. The configuration may indicate that out-of-order transmission is allowed between downlink grant triggered aperiodic channel state information (such as aperiodic channel state information 710 on physical uplink control channel) and uplink grant triggered aperiodic channel state information (such as aperiodic channel state information 720 on physical uplink control channel). In one example, the configuration may indicate that downlink grant triggered periodic channel state information (such as aperiodic channel state information 710) is allowed to be transmitted before uplink grant triggered periodic channel state information (such as aperiodic channel state information 720) if the uplink grant 715 is received prior to the downlink grant 705. Additionally or alternatively, the configuration may indicate that downlink grant triggered periodic channel state information (such as aperiodic channel state information 710) is not allowed to be transmitted before uplink grant triggered periodic channel state information (such as aperiodic channel state information 720) if the downlink grant 705 is received after the uplink grant 715. In some examples, the UE may receive the uplink grant 715 including an indication to report a channel state information 720. In some cases, the uplink grant 715 may be received prior to the downlink grant 705. In such cases, the UE may transmit the aperiodic channel state information 710 prior to transmitting the aperiodic channel state information 720. Additionally or alternatively, the configuration may indicate that the channel state information 710 is allowed to be transmitted no earlier than the channel state information 720.

In some examples, the UE may determine that the channel state information 710 and the channel state information 720 are associated with the same channel state information report configuration (or same channel state information resource configuration). In such examples, the UE may refrain from transmitting the channel state information 720 based on determining that the channel state information 710 and the channel state information 720 are associated with the same channel state information report configuration. According to one or more aspects, the UE may determine that the configuration indicates that out-of-order transmission is allowed between downlink grant triggered aperiodic channel state information (such as aperiodic channel state information 710 on physical uplink control channel) and uplink grant triggered aperiodic channel state information (such as aperiodic channel state information 720 on physical uplink control channel) if a shorter timeline is used or defined for downlink grant triggered aperiodic channel state information report on physical uplink control channel than the timeline for uplink grant triggered aperiodic channel state information report on physical uplink shared channel. For example, the UE may determine that a timeline associated with the downlink grant 705 is less than a timeline associated with the uplink grant 715. In such cases, the UE may transmit the channel state information 710 prior to transmitting the channel state information 720 based on determining that the timeline associated with the downlink grant 705 is less than the timeline associated with the uplink grant 715.

In the example of FIG. 7B, the UE (such as UE 115) may receive a downlink grant 755 including an indication to report a first channel state information 760 (such as an aperiodic channel state information). The UE may also receive an uplink grant 765 including an indication to report a second channel state information 770. In some examples, the UE may receive the uplink grant 765 after receiving the downlink grant 755. In some examples, the UE may determine a transmission order based on a configuration received from a base station or otherwise identified by the UE. The configuration may indicate that out-of-order transmission is not allowed between uplink grant triggered aperiodic channel state information (e.g., aperiodic channel state information 770) and downlink grant triggered aperiodic channel state information (e.g., aperiodic channel state information 760). For example, the configuration may indicate that the first channel state information 760 is not allowed to be transmitted earlier than the second channel state information 770.

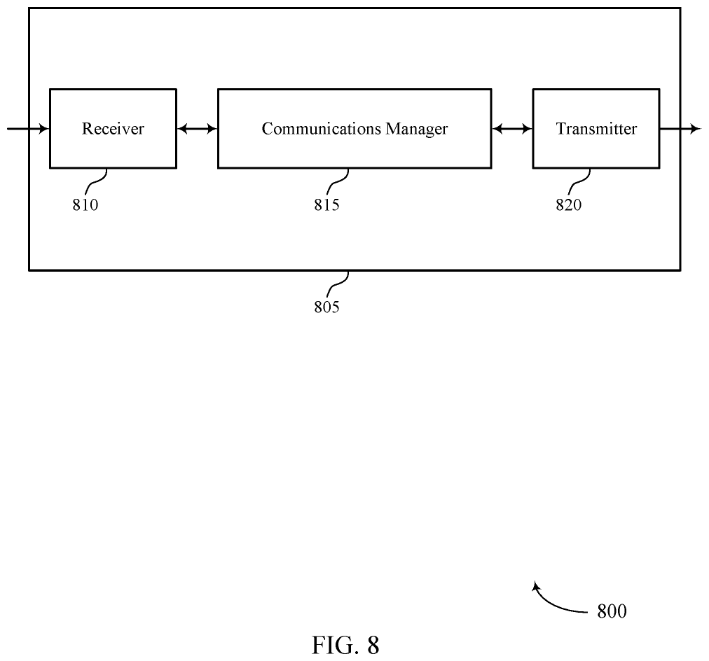

FIG. 8 shows a block diagram 800 of a device 805 that supports transmission order determination for aperiodic channel state information in accordance with aspects of the present disclosure. The device 805 may be an example of aspects of a UE 115 as described herein. The device 805 may include a receiver 810, a communications manager 815, and a transmitter 820. The device 805 may also include a processor. Each of these components may be in communication with one another (e.g., via one or more buses).

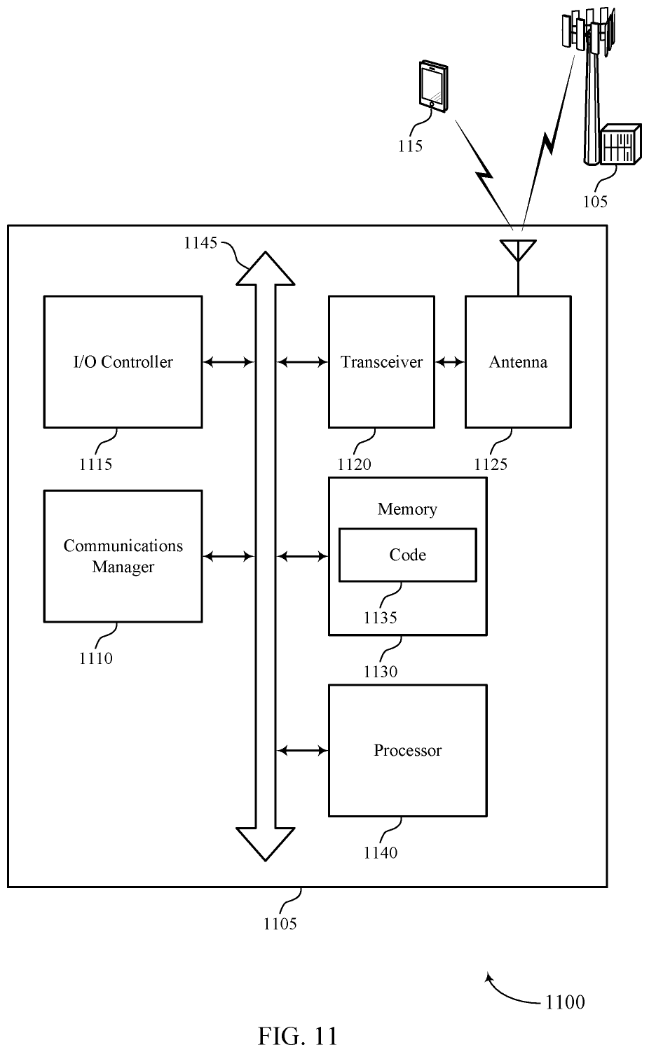

The receiver 810 may receive information such as packets, user data, or control information associated with various information channels (e.g., control channels, data channels, and information related to transmission order determination for aperiodic channel state information, etc.). Information may be passed on to other components of the device 805. The receiver 810 may be an example of aspects of the transceiver 1120 described with reference to FIG. 11. The receiver 810 may utilize a single antenna or a set of antennas.

The communications manager 815 may receive a downlink grant including an indication to report a first channel state information, receive a second grant including an indication to report a second channel state information, where the second grant is received after the downlink grant, determine a transmission order associated with the first channel state information and the second channel state information based on a configuration, and transmit the first channel state information and the second channel state information according to the transmission order. The communications manager 815 may be an example of aspects of the communications manager 1110 described herein.

The communications manager 815, or its sub-components, may be implemented in hardware, software (e.g., executed by a processor), or any combination thereof. If implemented in code executed by a processor, the functions of the communications manager 815, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 815, or its sub-components, may be physically located at various positions, including being distributed such that portions of functions are implemented at different physical locations by one or more physical components. In some examples, the communications manager 815, or its sub-components, may be a separate and distinct component in accordance with various aspects of the present disclosure. In some examples, the communications manager 815, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 820 may transmit signals generated by other components of the device 805. In some examples, the transmitter 820 may be collocated with a receiver 810 in a transceiver module. For example, the transmitter 820 may be an example of aspects of the transceiver 1120 described with reference to FIG. 11. The transmitter 820 may utilize a single antenna or a set of antennas.

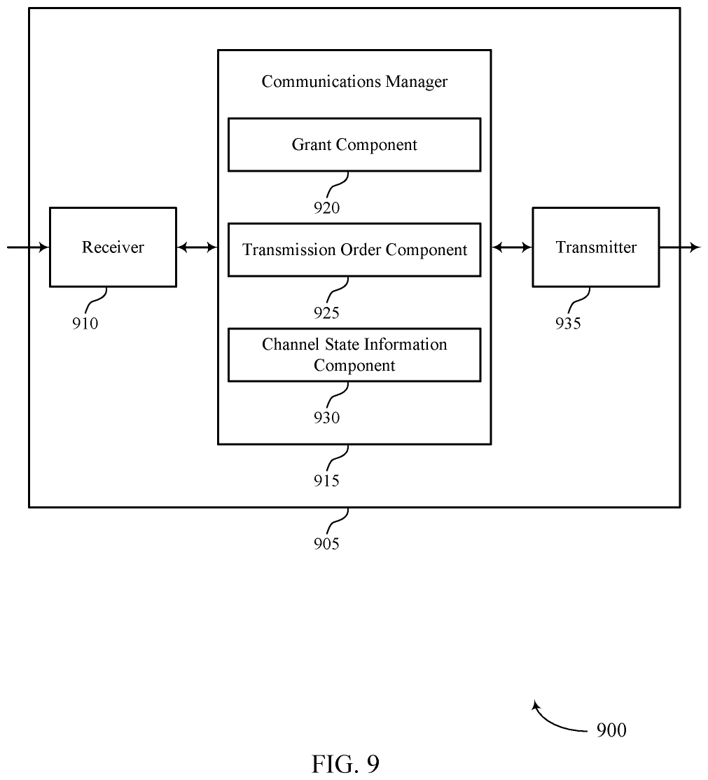

FIG. 9 shows a block diagram 900 of a device 905 that supports transmission order determination for aperiodic channel state information in accordance with aspects of the present disclosure. The device 905 may be an example of aspects of a device 805, or a UE 115 as described herein. The device 905 may include a receiver 910, a communications manager 915, and a transmitter 935. The device 905 may also include a processor. Each of these components may be in communication with one another (e.g., via one or more buses).

The receiver 910 may receive information such as packets, user data, or control information associated with various information channels (e.g., control channels, data channels, and information related to transmission order determination for aperiodic channel state information, etc.). Information may be passed on to other components of the device 905. The receiver 910 may be an example of aspects of the transceiver 1120 described with reference to FIG. 11. The receiver 910 may utilize a single antenna or a set of antennas.

The communications manager 915 may be an example of aspects of the communications manager 815 as described herein. The communications manager 915 may include a grant component 920, a transmission order component 925, and a channel state information component 930. The communications manager 915 may be an example of aspects of the communications manager 1110 described herein. The grant component 920 may receive a downlink grant including an indication to report a first channel state information and receive a second grant including an indication to report a second channel state information, where the second grant is received after the downlink grant. The transmission order component 925 may determine a transmission order associated with the first channel state information and the second channel state information based on a configuration. The channel state information component 930 may transmit the first channel state information and the second channel state information according to the transmission order.

The transmitter 935 may transmit signals generated by other components of the device 905. In some examples, the transmitter 935 may be collocated with a receiver 910 in a transceiver module. For example, the transmitter 935 may be an example of aspects of the transceiver 1120 described with reference to FIG. 11. The transmitter 935 may utilize a single antenna or a set of antennas.

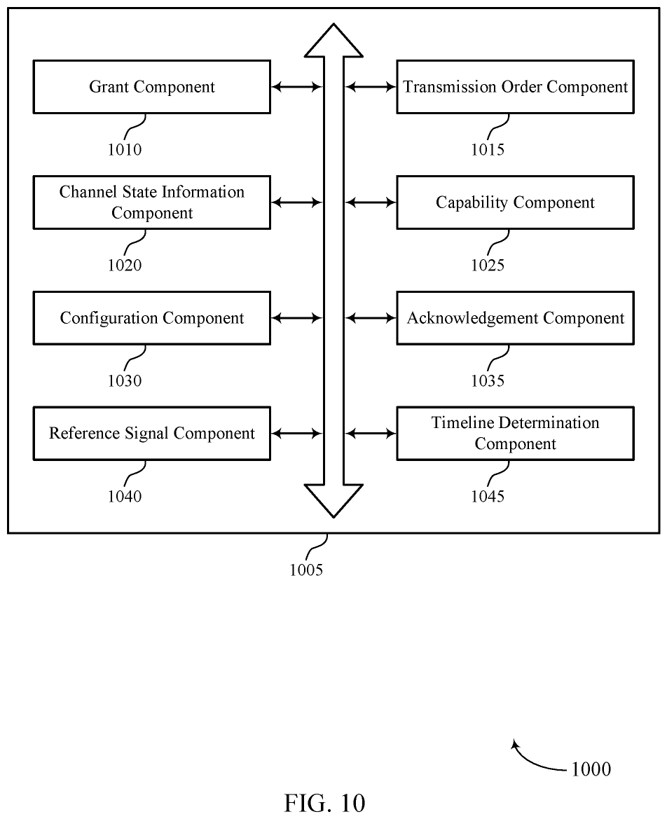

FIG. 10 shows a block diagram 1000 of a communications manager 1005 that supports transmission order determination for aperiodic channel state information in accordance with aspects of the present disclosure. The communications manager 1005 may be an example of aspects of a communications manager 815, a communications manager 915, or a communications manager 1110 described herein. The communications manager 1005 may include a grant component 1010, a transmission order component 1015, a channel state information component 1020, a capability component 1025, a configuration component 1030, an acknowledgement component 1035, a reference signal component 1040, and a timeline determination component 1045. Each of these modules may communicate, directly or indirectly, with one another (e.g., via one or more buses).

The grant component 1010 may receive a downlink grant including an indication to report a first channel state information. In some examples, the grant component 1010 may receive a second grant including an indication to report a second channel state information, where the second grant is received after the downlink grant.

The transmission order component 1015 may determine a transmission order associated with the first channel state information and the second channel state information based on a configuration. The channel state information component 1020 may transmit the first channel state information and the second channel state information according to the transmission order.

The capability component 1025 may transmit, to a base station, UE capability information indicating a capability of the UE to support the transmission order. The configuration component 1030 may receive the configuration from the base station, where the configuration is based on the UE capability information.

In some examples, the grant component 1010 may determine that the second grant is a second downlink grant. In some examples, the channel state information component 1020 may identify that the first channel state information and the second channel state information are associated with a first aperiodic channel state information type. The acknowledgement component 1035 may determine, based on the identifying, a first acknowledgement associated with the downlink grant and a second acknowledgement associated with the second downlink grant. In some cases, the configuration indicates that the first channel state information and the first acknowledgement is to be transmitted in a first slot and the second channel state information and the second acknowledgement is to be transmitted in a second slot, the first slot being no later than the second slot.

In some examples, the grant component 1010 may determine that the second grant is a second downlink grant. In some examples, the channel state information component 1020 may identify that the first channel state information and the second channel state information are associated with a second aperiodic channel state information type.

In some examples, the transmission order component 1015 may determine an ending symbol associated with a transmission of the first channel state information, where the configuration indicates that the second acknowledgement is to be transmitted no earlier than the ending symbol associated with the transmission of the first channel state information. In some examples, the transmission order component 1015 may determine a starting symbol associated with a transmission of the first channel state information, where the configuration indicates that the second channel state information is to be transmitted no earlier than the starting symbol associated with the transmission of the first channel state information. In some cases, the configuration indicates that the first channel state information is to be transmitted no later than the second channel state information. In some cases, the first channel state information and the second channel state information are transmitted in the same slot.

In some examples, the transmission order component 1015 may determine an ending symbol associated with a transmission of the first channel state information, where the configuration indicates that the second channel state information is to be transmitted no earlier than the ending symbol associated with the transmission of the first channel state information. In some cases, the configuration indicates that the first channel state information is to be transmitted in a first slot and the second channel state information is to be transmitted in a second slot, the first slot being no later than the second slot. In some cases, the configuration indicates that the second acknowledgement associated with the second downlink grant is allowed to be scheduled earlier than the first channel state information.

In some examples, the grant component 1010 may determine that the second grant is a second downlink grant. The reference signal component 1040 may receive a first channel state information reference signal associated with the downlink grant and a second channel state information reference signal associated with the second downlink grant.

In some cases, the configuration indicates that the first channel state information reference signal is allowed to be received earlier than the second channel state information reference signal. In some cases, the configuration indicates that the first channel state information is allowed to be transmitted earlier than the reception of the second channel state information reference signal. In some cases, the configuration indicates that the second channel state information reference signal is allowed to be received earlier than the transmission of the first channel state information.

In some examples, the grant component 1010 may receive an uplink grant including an indication to report a third channel state information, where the uplink grant is received prior to the downlink grant, and where transmitting the first channel state information includes transmitting the first channel state information prior to transmitting the third channel state information. In some examples, the grant component 1010 may receive an uplink grant including an indication to report a third channel state information, where the uplink grant is received prior to the downlink grant, and where the configuration indicates that the first channel state information is allowed to be transmitted no earlier than the third channel state information.

In some examples, the grant component 1010 may receive a third grant including an indication to report a third channel state information. In some examples, the channel state information component 1020 may determine that the first channel state information and the third channel state information are associated with the same channel state information report configuration. In some examples, the channel state information component 1020 may refrain from transmitting the third channel state information based on determining that the first channel state information and the third channel state information are associated with the same channel state information report configuration.

In some examples, the grant component 1010 may receive an uplink grant including an indication to report a third channel state information, where the uplink grant is received prior to the downlink grant. The timeline determination component 1045 may determine that a timeline associated with the downlink grant is less than a timeline associated with the uplink grant. In some examples, the channel state information component 1020 may transmit the first channel state information prior to transmitting the third channel state information based on determining that the timeline associated with the downlink grant is less than the timeline associated with the uplink grant.

In some examples, the grant component 1010 may determine that the second grant is an uplink grant, where the configuration indicates that the first channel state information is allowed to be transmitted earlier than the second channel state information.

In some examples, the channel state information component 1020 may transmit the second channel state information using a physical uplink shared channel. In some examples, the channel state information component 1020 may transmit the first channel state information using a physical uplink control channel. In some cases, the first channel state information and the second channel state information each include an aperiodic channel state information.

FIG. 11 shows a diagram of a system 1100 including a device 1105 that supports transmission order determination for aperiodic channel state information in accordance with aspects of the present disclosure. The device 1105 may be an example of or include the components of device 805, device 905, or a UE 115 as described herein. The device 1105 may include components for bi-directional voice and data communications including components for transmitting and receiving communications, including a communications manager 1110, an I/O controller 1115, a transceiver 1120, an antenna 1125, memory 1130, and a processor 1140. These components may be in electronic communication via one or more buses (e.g., bus 1145).

The communications manager 1110 may receive a downlink grant including an indication to report a first channel state information, receive a second grant including an indication to report a second channel state information, where the second grant is received after the downlink grant, determine a transmission order associated with the first channel state information and the second channel state information based on a configuration, and transmit the first channel state information and the second channel state information according to the transmission order.

The I/O controller 1115 may manage input and output signals for the device 1105. The I/O controller 1115 may also manage peripherals not integrated into the device 1105. In some cases, the I/O controller 1115 may represent a physical connection or port to an external peripheral. In some cases, the I/O controller 1115 may utilize an operating system such as iOS®, ANDROID®, MS-DOS®, MS-WINDOWS®, OS/2®, UNIX®, LINUX®, or another known operating system. In other cases, the I/O controller 1115 may represent or interact with a modem, a keyboard, a mouse, a touchscreen, or a similar device. In some cases, the I/O controller 1115 may be implemented as part of a processor. In some cases, a user may interact with the device 1105 via the I/O controller 1115 or via hardware components controlled by the I/O controller 1115.

The transceiver 1120 may communicate bi-directionally, via one or more antennas, wired, or wireless links as described above. For example, the transceiver 1120 may represent a wireless transceiver and may communicate bi-directionally with another wireless transceiver. The transceiver 1120 may also include a modem to modulate the packets and provide the modulated packets to the antennas for transmission, and to demodulate packets received from the antennas.

In some cases, the wireless device may include a single antenna 1125. However, in some cases the device may have more than one antenna 1125, which may be capable of concurrently transmitting or receiving multiple wireless transmissions.

The memory 1130 may include RAM and ROM. The memory 1130 may store computer-readable, computer-executable code 1135 including instructions that, when executed, cause the processor to perform various functions described herein. In some cases, the memory 1130 may contain, among other things, a BIOS which may control basic hardware or software operation such as the interaction with peripheral components or devices.

The processor 1140 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting transmission order determination for aperiodic channel state information).

The code 1135 may include instructions to implement aspects of the present disclosure, including instructions to support wireless communications. The code 1135 may be stored in a non-transitory computer-readable medium such as system memory or other type of memory. In some cases, the code 1135 may not be directly executable by the processor 1140 but may cause a computer (e.g., when compiled and executed) to perform functions described herein.

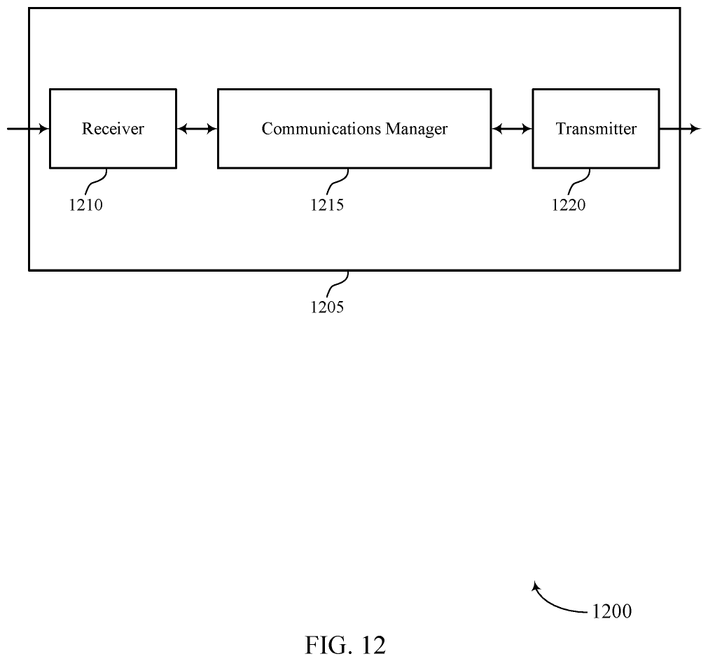

FIG. 12 shows a block diagram 1200 of a device 1205 that supports transmission order determination for aperiodic channel state information in accordance with aspects of the present disclosure. The device 1205 may be an example of aspects of a base station 105 as described herein. The device 1205 may include a receiver 1210, a communications manager 1215, and a transmitter 1220. The device 1205 may also include a processor. Each of these components may be in communication with one another (e.g., via one or more buses).

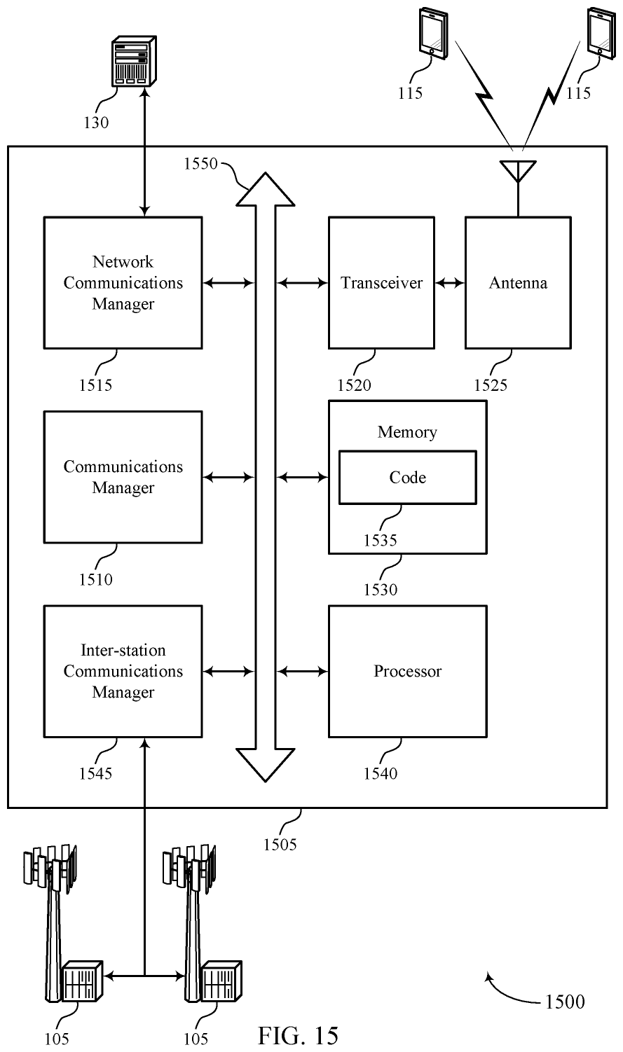

The receiver 1210 may receive information such as packets, user data, or control information associated with various information channels (e.g., control channels, data channels, and information related to transmission order determination for aperiodic channel state information, etc.). Information may be passed on to other components of the device 1205. The receiver 1210 may be an example of aspects of the transceiver 1520 described with reference to FIG. 15. The receiver 1210 may utilize a single antenna or a set of antennas.

The communications manager 1215 may determine a configuration for a transmission order associated with a first channel state information and a second channel state information, transmit, to a UE, the configuration indicating the transmission order, transmit a downlink grant including an indication to report the first channel state information, transmit a second grant including an indication to report the second channel state information, where the second grant is transmitted after the downlink grant, and receive the first channel state information and the second channel state information according to the transmission order. The communications manager 1215 may be an example of aspects of the communications manager 1510 described herein.

The communications manager 1215, or its sub-components, may be implemented in hardware, software (e.g., executed by a processor), or any combination thereof. If implemented in code executed by a processor, the functions of the communications manager 1215, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1215, or its sub-components, may be physically located at various positions, including being distributed such that portions of functions are implemented at different physical locations by one or more physical components. In some examples, the communications manager 1215, or its sub-components, may be a separate and distinct component in accordance with various aspects of the present disclosure. In some examples, the communications manager 1215, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1220 may transmit signals generated by other components of the device 1205. In some examples, the transmitter 1220 may be collocated with a receiver 1210 in a transceiver module. For example, the transmitter 1220 may be an example of aspects of the transceiver 1520 described with reference to FIG. 15. The transmitter 1220 may utilize a single antenna or a set of antennas.

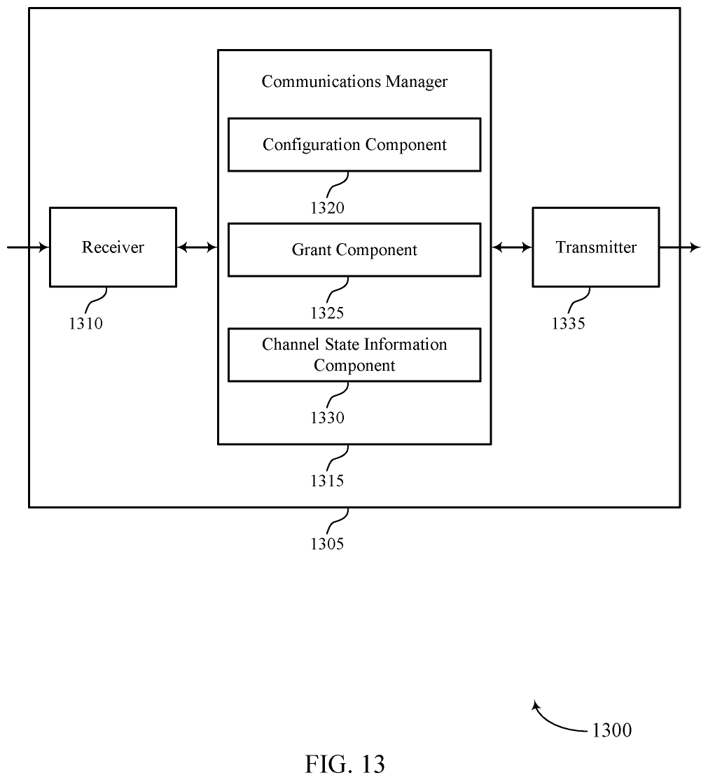

FIG. 13 shows a block diagram 1300 of a device 1305 that supports transmission order determination for aperiodic channel state information in accordance with aspects of the present disclosure. The device 1305 may be an example of aspects of a device 1205, or a base station 105 as described herein. The device 1305 may include a receiver 1310, a communications manager 1315, and a transmitter 1335. The device 1305 may also include a processor. Each of these components may be in communication with one another (e.g., via one or more buses).

The receiver 1310 may receive information such as packets, user data, or control information associated with various information channels (e.g., control channels, data channels, and information related to transmission order determination for aperiodic channel state information, etc.). Information may be passed on to other components of the device 1305. The receiver 1310 may be an example of aspects of the transceiver 1520 described with reference to FIG. 15. The receiver 1310 may utilize a single antenna or a set of antennas.

The communications manager 1315 may be an example of aspects of the communications manager 1215 as described herein. The communications manager 1315 may include a configuration component 1320, a grant component 1325, and a channel state information component 1330. The communications manager 1315 may be an example of aspects of the communications manager 1510 described herein.

The configuration component 1320 may determine a configuration for a transmission order associated with a first channel state information and a second channel state information and transmit, to a UE, the configuration indicating the transmission order. The grant component 1325 may transmit a downlink grant including an indication to report the first channel state information and transmit a second grant including an indication to report the second channel state information, where the second grant is transmitted after the downlink grant. The channel state information component 1330 may receive the first channel state information and the second channel state information according to the transmission order.

The transmitter 1335 may transmit signals generated by other components of the device 1305. In some examples, the transmitter 1335 may be collocated with a receiver 1310 in a transceiver module. For example, the transmitter 1335 may be an example of aspects of the transceiver 1520 described with reference to FIG. 15. The transmitter 1335 may utilize a single antenna or a set of antennas.

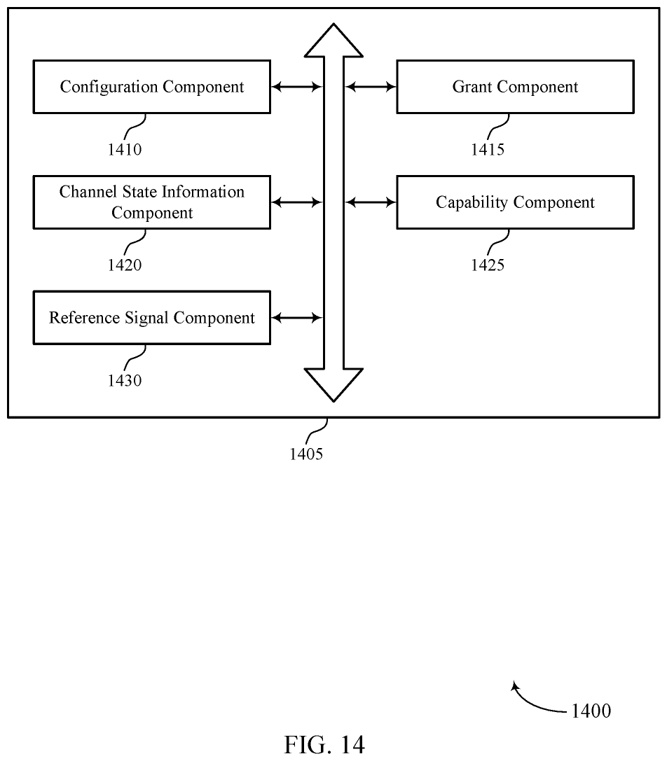

FIG. 14 shows a block diagram 1400 of a communications manager 1405 that supports transmission order determination for aperiodic channel state information in accordance with aspects of the present disclosure. The communications manager 1405 may be an example of aspects of a communications manager 1215, a communications manager 1315, or a communications manager 1510 described herein. The communications manager 1405 may include a configuration component 1410, a grant component 1415, a channel state information component 1420, a capability component 1425, and a reference signal component 1430. Each of these modules may communicate, directly or indirectly, with one another (e.g., via one or more buses).

The configuration component 1410 may determine a configuration for a transmission order associated with a first channel state information and a second channel state information. In some examples, the configuration component 1410 may transmit, to a UE, the configuration indicating the transmission order.

The grant component 1415 may transmit a downlink grant including an indication to report the first channel state information. In some examples, the grant component 1415 may transmit a second grant including an indication to report the second channel state information, where the second grant is transmitted after the downlink grant. The channel state information component 1420 may receive the first channel state information and the second channel state information according to the transmission order.

The capability component 1425 may receive, from the UE, UE capability information indicating a capability of the UE to support the transmission order, where determining the configuration is based on the UE capability information. In some examples, the grant component 1415 may determine that the second grant is a second downlink grant. In some examples, the channel state information component 1420 may identify that the first channel state information and the second channel state information are associated with a first aperiodic channel state information type.

In some cases, the configuration indicates that the first channel state information and a first acknowledgement associated with the downlink grant is to be transmitted in a first slot and the second channel state information and a second acknowledgement associated with the second downlink grant is to be transmitted in a second slot, the first slot being no later than the second slot.

In some examples, the channel state information component 1420 may identify that the first channel state information and the second channel state information are associated with a second aperiodic channel state information type. In some cases, the configuration indicates that a second acknowledgement associated with the second downlink grant is to be transmitted no earlier than a starting symbol associated with a transmission of the first channel state information. In some cases, the configuration indicates that a second acknowledgement associated with the second downlink grant is to be transmitted no earlier than an ending symbol associated with a transmission of the first channel state information.

In some cases, the configuration indicates that the first channel state information is to be transmitted no later than the second channel state information. In some cases, the configuration indicates that the second channel state information is to be transmitted no earlier than a starting symbol associated with a transmission of the first channel state information. In some cases, the configuration indicates that the second channel state information is to be transmitted no earlier than an ending symbol associated with a transmission of the first channel state information. In some cases, the configuration indicates that the first channel state information is to be transmitted in a first slot and the second channel state information is to be transmitted in a second slot, the first slot being no later than the second slot. In some cases, the configuration indicates that a second acknowledgement associated with the second downlink grant is allowed to be scheduled earlier than the first channel state information.

The reference signal component 1430 may transmit a first channel state information reference signal associated with the downlink grant and a second channel state information reference signal associated with the second downlink grant. In some cases, the configuration indicates that the first channel state information reference signal is allowed to be received earlier than the second channel state information reference signal. In some cases, the configuration indicates that the first channel state information is allowed to be transmitted earlier than the reception of the second channel state information reference signal. In some cases, the configuration indicates that the second channel state information reference signal is allowed to be received earlier than the transmission of the first channel state information.

In some examples, the grant component 1415 may transmit an uplink grant including an indication to report a third channel state information, where the uplink grant is transmitted prior to the downlink grant, and where receiving the first channel state information includes receiving the first channel state information prior to receiving the third channel state information. In some examples, the grant component 1415 may transmit an uplink grant including an indication to report a third channel state information, where the uplink grant is transmitted prior to the downlink grant, and where the configuration indicates that the first channel state information is allowed to be transmitted no earlier than the third channel state information.

In some examples, the grant component 1415 may transmit an uplink grant including an indication to report a third channel state information, where the uplink grant is transmitted prior to the downlink grant. In some examples, the grant component 1415 may determine that the second grant is an uplink grant, where the configuration indicates that the first channel state information is allowed to be transmitted earlier than the second channel state information.

In some examples, the channel state information component 1420 may receive the first channel state information prior to receiving the third channel state information based on a timeline associated with the downlink grant being less than a timeline associated with the uplink grant. In some examples, the channel state information component 1420 may receive the second channel state information using a physical uplink shared channel. In some examples, the channel state information component 1420 may receive the first channel state information using a physical uplink control channel. In some cases, the first channel state information and the second channel state information are received in the same slot. In some cases, the first channel state information and the second channel state information each include an aperiodic channel state information.

FIG. 15 shows a diagram of a system 1500 including a device 1505 that supports transmission order determination for aperiodic channel state information in accordance with aspects of the present disclosure. The device 1505 may be an example of or include the components of device 1205, device 1305, or a base station 105 as described herein. The device 1505 may include components for bi-directional voice and data communications including components for transmitting and receiving communications, including a communications manager 1510, a network communications manager 1515, a transceiver 1520, an antenna 1525, memory 1530, a processor 1540, and an inter-station communications manager 1545. These components may be in electronic communication via one or more buses (e.g., bus 1550).

The communications manager 1510 may determine a configuration for a transmission order associated with a first channel state information and a second channel state information, transmit, to a UE, the configuration indicating the transmission order, transmit a downlink grant including an indication to report the first channel state information, transmit a second grant including an indication to report the second channel state information, where the second grant is transmitted after the downlink grant, and receive the first channel state information and the second channel state information according to the transmission order.

The network communications manager 1515 may manage communications with the core network (e.g., via one or more wired backhaul links). For example, the network communications manager 1515 may manage the transfer of data communications for client devices, such as one or more UEs 115.

The transceiver 1520 may communicate bi-directionally, via one or more antennas, wired, or wireless links as described above. For example, the transceiver 1520 may represent a wireless transceiver and may communicate bi-directionally with another wireless transceiver. The transceiver 1520 may also include a modem to modulate the packets and provide the modulated packets to the antennas for transmission, and to demodulate packets received from the antennas.

In some cases, the wireless device may include a single antenna 1525. However, in some cases the device may have more than one antenna 1525, which may be capable of concurrently transmitting or receiving multiple wireless transmissions.

The memory 1530 may include RAM, ROM, or a combination thereof. The memory 1530 may store computer-readable code 1535 including instructions that, when executed by a processor (e.g., the processor 1540) cause the device to perform various functions described herein. In some cases, the memory 1530 may contain, among other things, a BIOS which may control basic hardware or software operation such as the interaction with peripheral components or devices.

The processor 1540 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some cases, a memory controller may be integrated into processor 1540. The processor 1540 may be configured to execute computer-readable instructions stored in a memory (e.g., the memory 1530) to cause the device 1505 to perform various functions (e.g., functions or tasks supporting transmission order determination for aperiodic channel state information).

The inter-station communications manager 1545 may manage communications with other base station 105, and may include a controller or scheduler for controlling communications with UEs 115 in cooperation with other base stations 105. For example, the inter-station communications manager 1545 may coordinate scheduling for transmissions to UEs 115 for various interference mitigation techniques such as beamforming or joint transmission. In some examples, the inter-station communications manager 1545 may provide an X2 interface within an LTE/LTE-A wireless communication network technology to provide communication between base stations 105.

The code 1535 may include instructions to implement aspects of the present disclosure, including instructions to support wireless communications. The code 1535 may be stored in a non-transitory computer-readable medium such as system memory or other type of memory. In some cases, the code 1535 may not be directly executable by the processor 1540 but may cause a computer (e.g., when compiled and executed) to perform functions described herein.

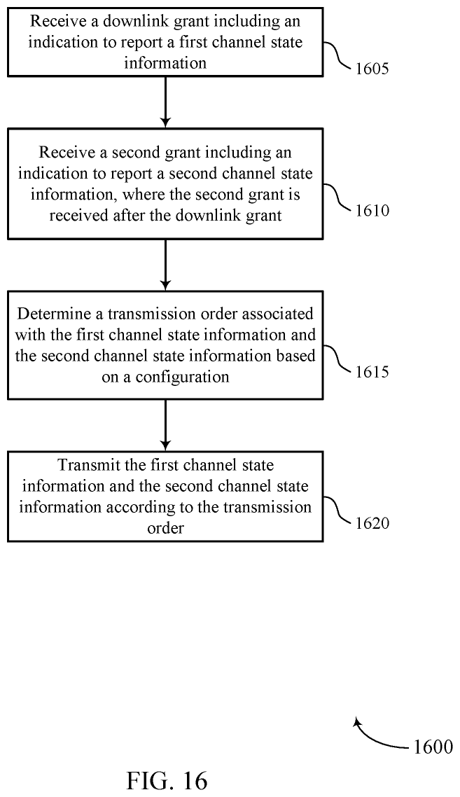

FIG. 16 shows a flowchart illustrating a method 1600 that supports transmission order determination for aperiodic channel state information in accordance with aspects of the present disclosure. The operations of method 1600 may be implemented by a UE 115 or its components as described herein. For example, the operations of method 1600 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1605, the UE may receive a downlink grant including an indication to report a first channel state information. The operations of 1605 may be performed according to the methods described herein. In some examples, aspects of the operations of 1605 may be performed by a grant component as described with reference to FIGS. 8 through 11.

At 1610, the UE may receive a second grant including an indication to report a second channel state information, where the second grant is received after the downlink grant. The operations of 1610 may be performed according to the methods described herein. In some examples, aspects of the operations of 1610 may be performed by a grant component as described with reference to FIGS. 8 through 11.

At 1615, the UE may determine a transmission order associated with the first channel state information and the second channel state information based on a configuration. The operations of 1615 may be performed according to the methods described herein. In some examples, aspects of the operations of 1615 may be performed by a transmission order component as described with reference to FIGS. 8 through 11.

At 1620, the UE may transmit the first channel state information and the second channel state information according to the transmission order. The operations of 1620 may be performed according to the methods described herein. In some examples, aspects of the operations of 1620 may be performed by a channel state information component as described with reference to FIGS. 8 through 11.

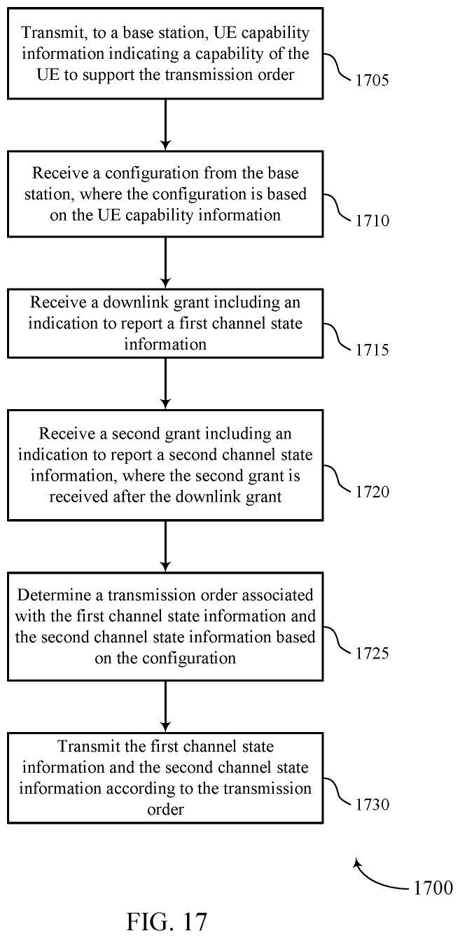

FIG. 17 shows a flowchart illustrating a method 1700 that supports transmission order determination for aperiodic channel state information in accordance with aspects of the present disclosure. The operations of method 1700 may be implemented by a UE 115 or its components as described herein. For example, the operations of method 1700 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1705, the UE may transmit, to a base station, UE capability information indicating a capability of the UE to support the transmission order. The operations of 1705 may be performed according to the methods described herein. In some examples, aspects of the operations of 1705 may be performed by a capability component as described with reference to FIGS. 8 through 11.

At 1710, the UE may receive a configuration from the base station, where the configuration is based on the UE capability information. The operations of 1710 may be performed according to the methods described herein. In some examples, aspects of the operations of 1710 may be performed by a configuration component as described with reference to FIGS. 8 through 11.

At 1715, the UE may receive a downlink grant including an indication to report a first channel state information. The operations of 1715 may be performed according to the methods described herein. In some examples, aspects of the operations of 1715 may be performed by a grant component as described with reference to FIGS. 8 through 11.

At 1720, the UE may receive a second grant including an indication to report a second channel state information, where the second grant is received after the downlink grant. The operations of 1720 may be performed according to the methods described herein. In some examples, aspects of the operations of 1720 may be performed by a grant component as described with reference to FIGS. 8 through 11.

At 1725, the UE may determine a transmission order associated with the first channel state information and the second channel state information based on the configuration. The operations of 1725 may be performed according to the methods described herein. In some examples, aspects of the operations of 1725 may be performed by a transmission order component as described with reference to FIGS. 8 through 11.

At 1730, the UE may transmit the first channel state information and the second channel state information according to the transmission order. The operations of 1730 may be performed according to the methods described herein. In some examples, aspects of the operations of 1730 may be performed by a channel state information component as described with reference to FIGS. 8 through 11.

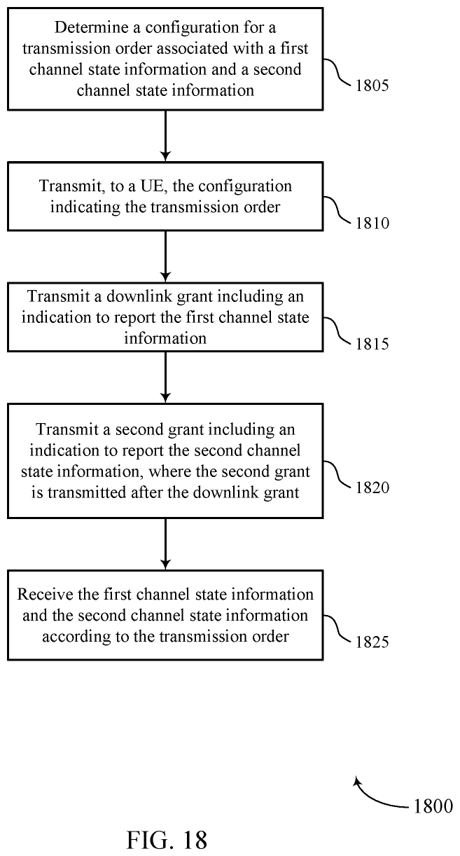

FIG. 18 shows a flowchart illustrating a method 1800 that supports transmission order determination for aperiodic channel state information in accordance with aspects of the present disclosure. The operations of method 1800 may be implemented by a base station 105 or its components as described herein. For example, the operations of method 1800 may be performed by a communications manager as described with reference to FIGS. 12 through 15. In some examples, a base station may execute a set of instructions to control the functional elements of the base station to perform the functions described below. Additionally or alternatively, a base station may perform aspects of the functions described below using special-purpose hardware.

At 1805, the base station may determine a configuration for a transmission order associated with a first channel state information and a second channel state information. The operations of 1805 may be performed according to the methods described herein. In some examples, aspects of the operations of 1805 may be performed by a configuration component as described with reference to FIGS. 12 through 15.

At 1810, the base station may transmit, to a UE, the configuration indicating the transmission order. The operations of 1810 may be performed according to the methods described herein. In some examples, aspects of the operations of 1810 may be performed by a configuration component as described with reference to FIGS. 12 through 15.

At 1815, the base station may transmit a downlink grant including an indication to report the first channel state information. The operations of 1815 may be performed according to the methods described herein. In some examples, aspects of the operations of 1815 may be performed by a grant component as described with reference to FIGS. 12 through 15.

At 1820, the base station may transmit a second grant including an indication to report the second channel state information, where the second grant is transmitted after the downlink grant. The operations of 1820 may be performed according to the methods described herein. In some examples, aspects of the operations of 1820 may be performed by a grant component as described with reference to FIGS. 12 through 15.

At 1825, the base station may receive the first channel state information and the second channel state information according to the transmission order. The operations of 1825 may be performed according to the methods described herein. In some examples, aspects of the operations of 1825 may be performed by a channel state information component as described with reference to FIGS. 12 through 15.

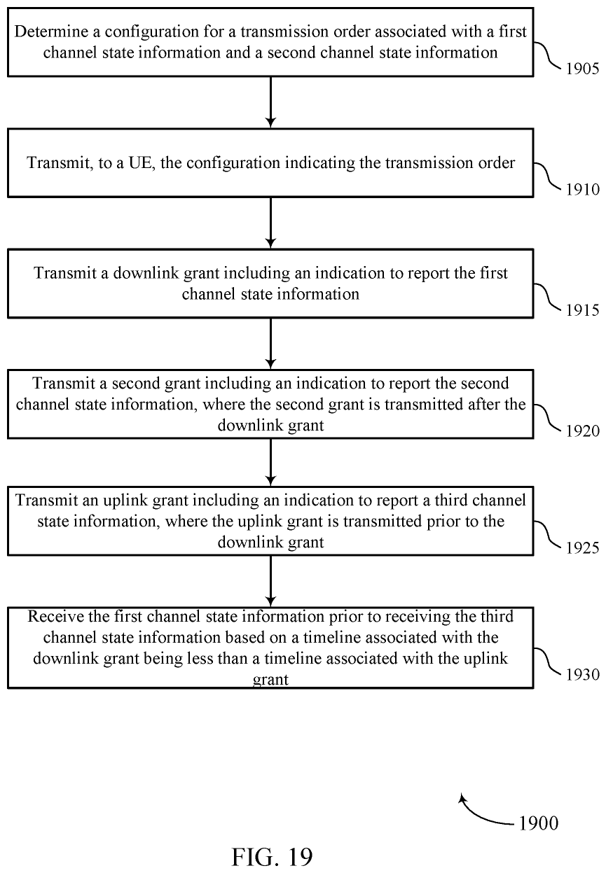

FIG. 19 shows a flowchart illustrating a method 1900 that supports transmission order determination for aperiodic channel state information in accordance with aspects of the present disclosure. The operations of method 1900 may be implemented by a base station 105 or its components as described herein. For example, the operations of method 1900 may be performed by a communications manager as described with reference to FIGS. 12 through 15. In some examples, a base station may execute a set of instructions to control the functional elements of the base station to perform the functions described below. Additionally or alternatively, a base station may perform aspects of the functions described below using special-purpose hardware.

At 1905, the base station may determine a configuration for a transmission order associated with a first channel state information and a second channel state information. The operations of 1905 may be performed according to the methods described herein. In some examples, aspects of the operations of 1905 may be performed by a configuration component as described with reference to FIGS. 12 through 15.

At 1910, the base station may transmit, to a UE, the configuration indicating the transmission order. The operations of 1910 may be performed according to the methods described herein. In some examples, aspects of the operations of 1910 may be performed by a configuration component as described with reference to FIGS. 12 through 15.

At 1915, the base station may transmit a downlink grant including an indication to report the first channel state information. The operations of 1915 may be performed according to the methods described herein. In some examples, aspects of the operations of 1915 may be performed by a grant component as described with reference to FIGS. 12 through 15.

At 1920, the base station may transmit a second grant including an indication to report the second channel state information, where the second grant is transmitted after the downlink grant. The operations of 1920 may be performed according to the methods described herein. In some examples, aspects of the operations of 1920 may be performed by a grant component as described with reference to FIGS. 12 through 15.

At 1925, the base station may transmit an uplink grant including an indication to report a third channel state information, where the uplink grant is transmitted prior to the downlink grant. The operations of 1925 may be performed according to the methods described herein. In some examples, aspects of the operations of 1925 may be performed by a grant component as described with reference to FIGS. 12 through 15.

At 1930, the base station may receive the first channel state information prior to receiving the third channel state information based on a timeline associated with the downlink grant being less than a timeline associated with the uplink grant. The operations of 1930 may be performed according to the methods described herein. In some examples, aspects of the operations of 1930 may be performed by a channel state information component as described with reference to FIGS. 12 through 15.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communication at a user equipment (UE), comprising:
receiving a downlink grant including an indication to report a first channel state information;
receiving a second grant including an indication to report a second channel state information, wherein the second grant is received after the downlink grant;
determining a transmission order associated with the first channel state information and the second channel state information based at least in part on a configuration; and
transmitting the first channel state information and the second channel state information according to the transmission order.

2. The method of claim 1, further comprising:
transmitting, to a network entity, UE capability information indicating a capability of the UE to support the transmission order; and
receiving the configuration from the network entity, wherein the configuration is based at least in part on the UE capability information.

3. The method of claim 1, further comprising:
determining that the second grant is a second downlink grant;
identifying that the first channel state information and the second channel state information are associated with a first aperiodic channel state information type; and
determining, based at least in part on the identifying, a first acknowledgement associated with the downlink grant and a second acknowledgement associated with the second downlink grant.

4. The method of claim 3, wherein the configuration indicates that the first channel state information and the first acknowledgement is to be transmitted in a first slot and the second channel state information and the second acknowledgement is to be transmitted in a second slot, the first slot being no later than the second slot.

5. The method of claim 1, further comprising:
determining that the second grant is a second downlink grant;
identifying that the first channel state information and the second channel state information are associated with a second aperiodic channel state information type; and
determining, based at least in part on the identifying, a first acknowledgement associated with the downlink grant and a second acknowledgement associated with the second downlink grant.

6. The method of claim 5, wherein determining the transmission order associated with the first channel state information and the second channel state information comprises:
determining a starting symbol associated with a transmission of the first channel state information, wherein the configuration indicates that the second acknowledgement is to be transmitted no earlier than the starting symbol associated with the transmission of the first channel state information.

7. The method of claim 5, wherein determining the transmission order associated with the first channel state information and the second channel state information comprises:
determining an ending symbol associated with a transmission of the first channel state information, wherein the configuration indicates that the second acknowledgement is to be transmitted no earlier than the ending symbol associated with the transmission of the first channel state information.

8. The method of claim 5, wherein the configuration indicates that the first channel state information is to be transmitted no later than the second channel state information.

9. The method of claim 8, wherein the first channel state information and the second channel state information are transmitted in the same slot.

10. The method of claim 5, wherein determining the transmission order associated with the first channel state information and the second channel state information comprises:
determining a starting symbol associated with a transmission of the first channel state information, wherein the configuration indicates that the second channel state information is to be transmitted no earlier than the starting symbol associated with the transmission of the first channel state information.

11. The method of claim 5, wherein determining the transmission order associated with the first channel state information and the second channel state information comprises:
determining an ending symbol associated with a transmission of the first channel state information, wherein the configuration indicates that the second channel state information is to be transmitted no earlier than the ending symbol associated with the transmission of the first channel state information.

12. The method of claim 5, wherein the configuration indicates that the first channel state information is to be transmitted in a first slot and the second channel state information is to be transmitted in a second slot, the first slot being no later than the second slot.

13. The method of claim 5, wherein the configuration indicates that the second acknowledgement associated with the second downlink grant is allowed to be scheduled earlier than the first channel state information.

14. The method of claim 1, further comprising:
determining that the second grant is a second downlink grant; and
receiving a first channel state information reference signal associated with the downlink grant and a second channel state information reference signal associated with the second downlink grant.

15. The method of claim 14, wherein the configuration indicates that the first channel state information reference signal is allowed to be received earlier than the second channel state information reference signal.

16. The method of claim 14, wherein the configuration indicates that the first channel state information is allowed to be transmitted earlier than the reception of the second channel state information reference signal.

17. The method of claim 14, wherein the configuration indicates that the second channel state information reference signal is allowed to be received earlier than the transmission of the first channel state information.

18. The method of claim 1, further comprising:
receiving an uplink grant including an indication to report a third channel state information, wherein the uplink grant is received prior to the downlink grant, and wherein transmitting the first channel state information comprises transmitting the first channel state information prior to transmitting the third channel state information.

19. The method of claim 1, further comprising:
receiving an uplink grant including an indication to report a third channel state information, wherein the uplink grant is received prior to the downlink grant, and wherein the configuration indicates that the first channel state information is allowed to be transmitted no earlier than the third channel state information.

20. The method of claim 1, further comprising:
receiving a third grant including an indication to report a third channel state information;
determining that the first channel state information and the third channel state information are associated with the same channel state information report configuration; and
refraining from transmitting the third channel state information based at least in part on determining that the first channel state information and the third channel state information are associated with the same channel state information report configuration.

21. The method of claim 1, further comprising:
receiving an uplink grant including an indication to report a third channel state information, wherein the uplink grant is received prior to the downlink grant;
determining that a timeline associated with the downlink grant is less than a timeline associated with the uplink grant; and
transmitting the first channel state information prior to transmitting the third channel state information based at least in part on determining that the timeline associated with the downlink grant is less than the timeline associated with the uplink grant.

22. The method of claim 1, further comprising:
determining that the second grant is an uplink grant, wherein the configuration indicates that the first channel state information is allowed to be transmitted earlier than the second channel state information.

23. The method of claim 22, wherein transmitting the second channel state information comprises:
transmitting the second channel state information using a physical uplink shared channel.

24. The method of claim 1, wherein transmitting the first channel state information comprises:
transmitting the first channel state information using a physical uplink control channel.

25. (canceled)

26. A method for wireless communication at a network entity, comprising:
determining a configuration for a transmission order associated with a first channel state information and a second channel state information;
transmitting, to a user equipment (UE), the configuration indicating the transmission order;
transmitting a downlink grant including an indication to report the first channel state information;
transmitting a second grant including an indication to report the second channel state information, wherein the second grant is transmitted after the downlink grant; and
receiving the first channel state information and the second channel state information according to the transmission order.

27. The method of claim 26, further comprising:
receiving, from the UE, UE capability information indicating a capability of the UE to support the transmission order, wherein determining the configuration is based at least in part on the UE capability information.

28. The method of claim 26, further comprising:
determining that the second grant is a second downlink grant; and
identifying that the first channel state information and the second channel state information are associated with a first aperiodic channel state information type.

29. The method of claim 28, wherein the configuration indicates that the first channel state information and a first acknowledgement associated with the downlink grant is to be transmitted in a first slot and the second channel state information and a second acknowledgement associated with the second downlink grant is to be transmitted in a second slot, the first slot being no later than the second slot.

30-49. (canceled)

50. An apparatus for wireless communication, comprising:
a processor,
memory coupled with the processor; and
instructions stored in the memory and executable by the processor to cause the apparatus to:
receive a downlink grant including an indication to report a first channel state information;
receive a second grant including an indication to report a second channel state information, wherein the second grant is received after the downlink grant;
determine a transmission order associated with the first channel state information and the second channel state information based at least in part on a configuration; and
transmit the first channel state information and the second channel state information according to the transmission order.

51. An apparatus for wireless communication, comprising:
a processor,
memory coupled with the processor; and
instructions stored in the memory and executable by the processor to cause the apparatus to:
determine a configuration for a transmission order associated with a first channel state information and a second channel state information;
transmit, to a user equipment (UE), the configuration indicating the transmission order;
transmit a downlink grant including an indication to report the first channel state information;
transmit a second grant including an indication to report the second channel state information, wherein the second grant is transmitted after the downlink grant; and
receive the first channel state information and the second channel state information according to the transmission order.

52-55. (canceled)
